(19) United States
(12) Patent Application Publication
(10) Pub. No.: US 2024/0199808 A1
(43) Pub. Date: Jun. 20, 2024

(54) POLYAMIDE COMPOSITION

(71) Applicant: INV NYLON CHEMICALS AMERICAS, LLC, Wilmington, DE (US)

(72) Inventors: Ali Syed Fareed, Kennesaw, GA (US); Chee Sern Lim, Kennesaw, GA (US)

(21) Appl. No.: 18/287,469

(22) PCT Filed: Apr. 22, 2022
(86) PCT No.: PCT/IB2022/053788

§ 371 Date: Oct. 19, 2023

Related U.S. Application Data
(60) Provisional application No. 63/178,259, filed on Apr. 22, 2021.

(51) Int. Cl. C08G 69/26; C08G 67/04; C08G 69/48; C08K 3/40; C08K 7/14

(52) U.S. Cl. CPC C08G 69/26; C08G 67/04; C08G 69/48; C08K 3/40; C08K 7/14

(57) ABSTRACT

The present disclosure relates to thermoplastic resin compositions with improved impact strength, tensile modulus, and/or ductility, such as under low-temperature conditions. The present disclosure relates to articles formed therefrom, such as molded or extruded articles. The composition can include a condensation polyamide and a maleated polyolefin, such as ≥10 wt % to ≤50 wt % of a maleated polyolefin having a grafted maleic anhydride incorporation of ≥0.05 to ≤1.5 wt % based on total weight of the maleated polyolefin.

### CROSS-REFERENCE TO RELATED APPLICATION

This application claims the benefit of priority to U.S. Provisional Patent Application Ser. No. 63/178,259 filed Apr. 22, 2021, the disclosure of which is incorporated herein in its entirety by reference.

### FIELD

The present disclosure relates to thermoplastic resin compositions with improved impact strength, tensile strength, and/or ductility, such as under conditions that are below 0° C.

### BACKGROUND

Thermoplastic condensation polyamide resins that are molded or extruded suffer from insufficient properties for various end uses such as automotive, electronics, chemical processing, and heat transfer applications. Various thermoplastic condensation polyamide resins that are molded or extruded have insufficient impact strength (or toughness) and ductility, especially at temperatures below 0° C., where most commercially available polyamide resins appear to fail.

### SUMMARY OF THE INVENTION

The present disclosure provides a composition including a condensation polyamide, or a reacted product of the composition, wherein when the composition or reacted product is formed into an impact test bar and tested at −30° C. according to ISO 179/2-1eA to form a −30° C. notched impact fractured surface, the composition or reacted product has: an S_{dr} measurement of ≥10% as obtained from a surface profilometry analysis of the −30° C. notched impact fractured surface, wherein S_{dr} represents the degree to which the actual surface area increases in comparison to a flat state; or a stress whitening zone thickness of ≥500 microns at a halfway distance through the fracture and in a transversal surface cut plane (T_{CUT}), the transversal cut plane being perpendicular to the original fracture surface; or a porosity area fraction (%) within the first 50 microns below the −30° C. notched impact fractured surface in a transverse cross-section direction taken at ≥3 to ≤5 mm linear distance from the notch is ≥5% to ≤31%; or a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch of ≥1.8 to ≤3.1 and a porosity area fraction measured in the same location as the numerical mean of the aspect ratio of at least 5%; or a combination thereof.

The present disclosure provides a composition including a condensation polyamide, or a reacted product of the composition, wherein when the composition or reacted product is formed into an impact test bar and tested at −30° C. according to ISO 179/2-1eA to form a −30° C. notched impact fractured surface, the composition or reacted product has: a porosity area fraction (%) within the first 50 microns below the −30° C. notched impact fractured surface in a transverse cross-section direction taken at ≥3 to ≤5 mm linear distance from the notch of ≥5% to ≤31%, and a porosity area fraction (%) at a depth of about 100 microns below the −30° C. notched impact fractured surface in a transverse cross-section direction taken at ≥3 to ≤5 mm linear distance from the notch of ≥2% to ≤17%.

The present disclosure provides a composition including a condensation polyamide, or a reacted product of the composition, wherein when the composition or reacted product thereof is formed into a tensile test bar according to ISO 527 and fractured at room temperature in accordance with ISO 527, it exhibits an internal microstructure having ≥4% porosity area fraction and an aspect ratio (pore major axis/minor axis) at a halfway point between the fracture surface and the grip sections and at the start of the grip sections of ≥1.6 to ≤3.0.

The present disclosure provides a composition including a condensation polyamide and a maleated polyolefin, or a reacted product of the composition, the condensation polyamide including nylon 66, wherein the amine end group (AEG) index of the nylon 66 is ≥65 and ≤130, wherein an unpolished microtome-cut pellet formed from the composition or reacted product thereof subjected to toluene etching at 90° C. for 2 hours has a surface that, as compared using a magnification of 3000× to 5000×, is less pitted than an identical composition or reacted product thereof wherein the amine end group (AEG) index of the nylon 66 is <65.

The composition can include the condensation polyamide, wherein the condensation polyamide is at least 30 wt % of the composition, wherein the condensation polyamide is the predominant polyamide in the composition. The composition can also include from ≥10 wt % to ≤50 wt % of maleated polyolefin, wherein the maleated polyolefin includes maleic anhydride grafted onto a polyolefin backbone, the maleated polyolefin having a grafted maleic anhydride incorporation of ≥0.05 to ≤1.5 wt % based on total weight of the maleated polyolefin.

The composition can include the condensation polyamide, wherein the condensation polyamide is at least 40 wt % of the composition, wherein the condensation polyamide is the predominant polyamide in the composition, wherein the condensation polyamide is nylon 66 having an AEG of ≥65 milliequivalents per kg (meq/kg) and ≤130 meq/kg. The composition can also include from ≥15 wt % to ≤45 wt % of maleated polyolefin, wherein the maleated polyolefin includes maleic anhydride grafted onto a polyolefin backbone, the maleated polyolefin having a grafted maleic anhydride incorporation of ≥0.05 to ≤1.5 wt % based on total weight of the maleated polyolefin.

The present disclosure provides an article formed from the composition or the reacted product thereof. The article can be an extruded or molded article.

The present disclosure provides a method of making the composition, the reacted product thereof, or a combination thereof. The method includes combining the condensation polyamide and the maleated polyolefin to form the composition, the reacted product, or a combination thereof.

The present disclosure provides a method of extrusion of a polyamide resin. The method includes providing the composition, the reacted product thereof, or the combination thereof, to a feed zone of an extruder. The method includes maintaining extruder barrel conditions sufficiently to obtain a polyamide resin melt inside the extruder. The method includes producing extrudate from the extruder while optionally recovering vapor from the extruder via a vacuum draw.

In general, industrially available polyamides such as nylon 66 are not known to have the adequate sub-zero impact resistance or ductility. An industrial need continues to exist for thermoplastic resins, particularly, in the field of polyamides, with superior impact resistance, toughness and ductility. Most applications require improved impact resistance and ductility at temperatures below 0° C., where most commercially available polyamide resins appear to fail. The formulations according to the present disclosure can provide improved impact resistance, tensile strength, solvent resistance, and/or ductility, such as at temperatures below 0° C.

### BRIEF DESCRIPTION OF THE FIGURES

The drawings illustrate generally, by way of example, but not by way of limitation, various aspects of the present invention.

FIGS. 1A-B illustrate SEM images of various Example 1 specimens according to the present disclosure.

FIGS. 2A-F illustrate SEM images of various Example 1 and 2 specimens according to the present disclosure.

FIGS. 3A-D illustrate 3-dimensional surface profilometry of various Example 1 and 2 specimens according to the present disclosure.

FIG. 4A is a diagram illustrating the orientations of longitudinal and transverse cuts from impact tested bars for various test specimens according to the present disclosure.

FIG. 4B illustrate photographs of various Example 1 and 2 specimens according to the present disclosure.

FIG. 5 illustrate SEM images showing microporosity characteristics of the Example 1E specimen according to the present disclosure.

FIG. 6 illustrates SEM images of various Example 1 and 2 impact tested specimens in the transverse orientation according to the present disclosure.

FIG. 7 illustrate SEM images of the Example 1E impact tested specimen in the longitudinal orientation at various lengths from the test notch according to the present disclosure.

FIG. 8 illustrates a plot of −30° C. impact strength (kJ/m²) versus room-temperature tensile modulus (GPa) data according to the present disclosure.

FIG. 9A illustrates sample locations analyzed in tensile tests performed in various Examples of the present disclosure.

FIG. 9B illustrates SEM images of various fractured tensile bars formed from Example 1 and 2 samples according to the present disclosure.

FIG. 10 illustrates SEM images of various Example 1 impact tested specimens in the transverse orientation according to the present disclosure.

FIG. 11 illustrate SEM images of various Example 1 impact tested specimens in the longitudinal orientation according to the present disclosure.

FIG. 12 illustrates SEM images of various Example 1 tensile tested specimens according to the present disclosure.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

As used herein, the term “polymer” refers to a molecule having at least one repeating unit and can include copolymers.

The term “conduit” or “conduit structure”, as used herein, may refer to a hollow channel or duct suitable for conveying a fluid or passage for laying down and enclosing thin electrical wires and cables. The conduit cross-section may have a single hole or multiple holes depending on the application requirement.

The term “pipe”, as used herein, may embody either right-cylindrical geometry, i.e., having circular cross-sectional shape, and other cross-sectional shapes which may be elongated in one axis perpendicular to the conduit long axis, for example, obround and oval cross-sectional shapes.

As used herein, “sheet” or “extruded planer sheet” refers to a broad and substantially flat or planer section of desired dimension. In some aspects, the sheet width can be in the range of 6-inch to 10-ft and the sheet thickness range may be 0.3-5 mm.

The term “PA6”, “N6” or “nylon 6”, as used herein, refers to a polymer synthesized by polycondensation of caprolactam. The polymer is also known as polyamide 6, PA6, or poly(caprolactam).

The term “N66” or “nylon 66”, as used herein, refers to a polymer synthesized by polycondensation of hexamethylenediamine (HMD) and adipic acid. The polymer is also known as polyamide 66 (or PA66), nylon 6,6, nylon 6-6, nylon 6/6 or nylon-6,6.

The term “N12” or “nylon 12”, as used herein, refers to a polymer synthesized by polycondensation of @-aminolauric acid or ring-opening polymerization of laurolactam. The polymer is also known as polyamide 12 (or PA12), nylon 12, poly(laurolactam), poly(dodecano-12-lactam), or poly(12-aminododecanoic acid lactam).

The term “N612” or “nylon 612”, as used herein, refers to a polymer synthesized by polycondensation of hexamethylenediamine (HMD) and α,ω-dodecanedioic acid (or C12 diacid). The polymer is also known as polyamide 612 (or PA612), PA 6/12, or nylon 6/12.

The term “nylon 66/6T”, as used herein, refers to a co-polymer obtained from N66 and a polymer of N6-terephthalic acid (TPA).

The term “nylon 66/6I”, as used herein, refer to a co-polymer obtained from N66 and a polymer of N6-isophthalic acid (IPA).

As used herein, “PA610” or “nylon-6,10” is a semi-crystalline polyamide prepared from hexamethylenediamine (C₆ diamine, abbreviated as HMD) and decanedioic acid (C₁₀ diacid). It is commercially available from Arkema, BASF, and such.

As used herein, “PA66/DI” or “nylon-66/DI” or “PA66/MPMD-I” refers to a type of co-polyamide of polyhexamethyleneadipamide (nylon-6,6 or N66 or PA66) and “DI” which is a combination of 2-methyl-pentamethylenediamine (or “MPMD”) and isophthalic acid. MPMD is commercially available as INVISTA Dytek® A amine and industrially known as “D” in the abbreviated formulation labeling. Isophthalic acid is commercially available and industrially known as “I” in the abbreviated formulation labeling.

In some aspects, PA66/DI may contain about 80-99% PA66 and about 1-20% DI on the mass basis, for example, about (on wt:wt basis) 99:1 or 97:3 or 95:5 or 92:8 or 90:10 or 85:15 or 80:20 for PA66:DI achieved for the salts on dry basis. The “DI” part in PA66/DI is about 50:50 (molar) or about 40:60 D:I (mass ratio). The RV range for PA66/DI can be between 35 and 60 and may contain amine end groups (AEG) between 40 to 80 meg/kg, for example, between 60 to 80 meg/kg, or 65 meg/kg, or 70 meg/kg. Standard batch evaporation and batch autoclave polymerization processes are used to produce the copolymer. These methods are polymerization processes generally known to the skilled person.

INVISTA Dytek® A amine is commercially produced by hydrogenating 2-methylglutaronitrile (or “MGN”). MGN is a branched C₆ dinitrile obtained as a side-product from butadiene double-hydrocyanation process of adiponitrile [or ‘ADN”] manufacture. The otherwise disposed MGN side-product can be recycled and reused in the production of INVISTA Dytek® A amine or the “D” portion; the PA66/DI produced by this process, therefore, is considered to have the recycled amine content coming from the “D” portion.

As used herein, “High-AEG polyamide 66” or “High AEG N66” is commercially available from INVISTA. High-AEG polyamide 66 is characterized by its RV range of 30-80, for example 35-75 RV, for example, 35-70 RV, and AEG of ≥65 milliequivalents per kg (meq/kg) and ≤130 meq/kg of the polyamide resin, for example ≥75 meq/kg and ≤125 meq/kg, ≥80 meq/kg and ≤125 meq/kg, ≥90 meq/kg and ≤120 meq/kg of the polyamide resin.

As used herein, “PA610” or “nylon-6,10” is a semi-crystalline polyamide prepared from hexamethylenediamine (C₆ diamine, abbreviated as HMD) and decanedioic acid (C₁₀ diacid). It is commercially available from Arkema, BASF, and such.

As used herein, “PA612” is commercially available from DuPont, EMS, Shakespeare, Nexis. PA612 is a semi-crystalline polyamide prepared from hexamethylenediamine (C₆ diamine, abbreviated as HMD) and dodecanedioic acid (C₁₂ diacid, abbreviated as DDDA).

As used herein, “FUSABOND™ N216” (previously known as “Amplify® GR216”) is a maleic anhydride grafted polyolefin and is commercially available from Dow Chemical.

As used herein, “ZeMac™ E60” is a chain extender that is a copolymer of maleic anhydride and ethylene and is commercially available from Vertellus.

As used herein, “Zytel® FE7108” is commercially available from DuPont, AmeriChem.

As used herein, “Stabaxol® P100” is a type of hydrolysis stabilizer commercially available from Lanxess.

As used herein, “room temperature” means ambient temperature, such as the ambient temperature under which testing is performed, such as about 23° C. (e.g., about 19° C. to about 27° C.).

### Composition Including a Condensation Polyamide and a Maleated Polyolefin.

The present invention provides a composition including a condensation polyamide, or a reacted product of the composition. When the composition or reacted product is formed into an impact test bar and tested at −30° C. according to ISO 179/2-1eA to form a −30° C. notched impact fractured surface, the composition or reacted product can have: an S_{dr} measurement of ≥10% as obtained from a surface profilometry analysis of the −30° C. notched impact fractured surface, wherein S_{dr} represents the degree to which the actual surface area increases in comparison to a flat state; or a stress whitening zone thickness of ≥500 microns at a halfway distance through the fracture and in a transversal surface cut plane (T_{CUT}), the transversal cut plane being perpendicular to the original fracture surface; or a porosity area fraction (%) measured within the first 50 microns below the −30° C. notched impact fractured surface in a transverse cross-section direction taken at ≥3 to ≤5 mm linear distance from the notch can be ≥5% to ≤31%; or a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch can be ≥1.8 to ≤3.1 and a porosity area fraction measured in the same location as the numerical mean of the aspect ratio can be at least 5%; or a combination thereof.

When the composition or reacted product is formed into an impact test bar and tested at −30° C. according to ISO 179/2-1eA to form a −30° C. notched impact fractured surface, the composition or reacted product can have an S_{dr} measurement of ≥10% as obtained from a surface profilometry analysis of the −30° C. notched impact fractured surface, wherein S_{dr} represents the degree to which the actual surface area increases in comparison to a flat state. For example, the S_{dr} can be 10% to 30%, or 10% to 20%, or 10% to 15%, or less than or equal to 30% but greater than or equal to 10%, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, or 29.5%.

When the composition or reacted product is formed into an impact test bar and tested at −30° C. according to ISO 179/2-1eA to form a −30° C. notched impact fractured surface, the composition or reacted product can have a stress whitening zone thickness of ≥500 microns at a halfway distance through the fracture and in a transversal surface cut plane (T_{CUT}), the transversal cut plane being perpendicular to the original fracture surface. For example, the stress whitening zone thickness can be 500 microns to 800 microns at a halfway distance through the fracture and in the T_{CUT} plane, or 550 microns to 700 microns, or less than or equal to 800 microns but greater than or equal to 500, 510, 520, 530, 540, 550, 560, 570, 580, 590, 600, 620, 640, 660, 680, 700, 720, 740, 760, or 780 microns.

When the composition or reacted product is formed into an impact test bar and tested at −30° C. according to ISO 179/2-1eA to form a −30° C. notched impact fractured surface, the composition or reacted product can have a porosity area fraction (%) measured within the first 50 microns below the −30° C. notched impact fractured surface in a transverse cross-section direction taken at ≥3 to ≤5 mm linear distance from the notch of ≥5% to ≤31%. For example, the porosity area fraction can be ≥5% to ≤31%, or ≥8% to ≤27%, or ≥12% to ≤23%, or equal to or less than 31% but greater than or equal to 4%, 5, 6, 7, 8, 9, 10, 11, 12, 13, 14, 15, 16, 17, 18, 19, 20, 21, 22, 23, 24, 25, 26, 27, 28, 29, or 30%.

When the composition or reacted product is formed into an impact test bar and tested at −30° C. according to ISO 179/2-1eA to form a −30° C. notched impact fractured surface, the composition or reacted product can have a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch can be ≥1.8 to ≤3.1. The numerical mean of the aspect ratio can be ≥1.8 to ≤3.1 and a porosity area fraction measured in the same location as the numerical mean of the aspect ratio can be at least 5%. For example, the numerical mean of the aspect ratio can be ≥1.8 to ≤3.1, ≥2.0 to ≤3.0, ≥2.1 to ≤2.8, or less than or equal to 3.1 but greater than or equal to 1.8, 1.9, 2, 2.1, 2.2, 2.3, 2.4, 2.5, 2.6, 2.7, 2.8, 2.9, or 3.0.

When the composition or reacted product is formed into an impact test bar and tested at −30° C. according to ISO 179/2-1eA to form a −30° C. notched impact fractured surface, the composition or reacted product can have a porosity area fraction (%) at a depth of about 100 microns below the −30° C. notched impact fractured surface in a transverse cross-section direction taken at ≥3 to ≤5 mm linear distance from the notch of ≥2% to ≤17%. For example, the porosity area fraction can be ≥2% to ≤17%, ≥3% to ≤14%, ≥4% to ≤12%, or less than or equal to 17% but greater than or equal to 2%, 3, 4, 5, 6, 7, 8, 9, 10, 11, 12, 13, 14, 15, or 16%.

The present invention provides a composition including a condensation polyamide, or a reacted product of the composition. When the composition or reacted product is formed into an impact test bar and tested at −30° C. according to ISO 179/2-1eA to form a −30° C. notched impact fractured surface, the composition or reacted product can have a porosity area fraction (%) within the first 50 microns below the −30° C. notched impact fractured surface in a transverse cross-section direction taken at ≥3 to ≤5 mm linear distance from the notch of ≥5% to ≤31% (e.g., ≥5% to ≤31%, or ≥8% to ≤27%, or ≥12% to ≤23%, or equal to or less than 31% but greater than or equal to 4%, 5, 6, 7, 8, 9, 10, 11, 12, 13, 14, 15, 16, 17, 18, 19, 20, 21, 22, 23, 24, 25, 26, 27, 28, 29, or 30%), and a porosity area fraction (%) at a depth of about 100 microns below the −30° C. notched impact fractured surface in a transverse cross-section direction taken at ≥3 to ≤5 mm linear distance from the notch of ≥2% to ≤17% (e.g., ≥2% to ≤17%, ≥3% to ≤14%, ≥4% to ≤12%, or less than or equal to 17% but greater than or equal to 2%, 3, 4, 5, 6, 7, 8, 9, 10, 11, 12, 13, 14, 15, or 16%). When the composition or reacted product thereof is formed into a tensile test bar according to ISO 527 and fractured at room temperature in accordance with ISO 527, it exhibits an internal microstructure having ≥4% porosity area fraction (e.g., e.g., ≥5% to ≤31%, or ≥8% to ≤27%, or ≥12% to ≤23%, or equal to or less than 31% but greater than or equal to 4%, 5, 6, 7, 8, 9, 10, 11, 12, 13, 14, 15, 16, 17, 18, 19, 20, 21, 22, 23, 24, 25, 26, 27, 28, 29, or 30%) and an aspect ratio (pore major axis/minor axis) at a halfway point between the fracture surface and the grip sections and at the start of the grip sections of ≥1.6 to ≤3.0 (e.g., ≥1.6 to ≤3.0, ≥1.7 to ≤2.8, ≥1.8 to ≤2.5, or less than or equal to 3 but greater than or equal to 1.6, 1.7, 1.8, 1.9, 2.0, 2.1, 2.2, 2.3, 2.4, 2.5, 2.6, 2.7, 2.8, or 2.9).

The present invention provides a composition including a condensation polyamide and a maleated polyolefin, or a reacted product of the composition. When the composition or reacted product is formed into an impact test bar and tested at −30° C. according to ISO 179/2-1eA to form a −30° C. notched impact fractured surface, the composition or reacted product can have increased cavitation upon impact fracture as compared to an identical composition or reacted product thereof (e.g., comparative composition or reacted product thereof) that is free of the maleated polyolefin and/or wherein the nylon 66 of the comparative composition or reacted product thereof has an amine end group (AEG) index of <65.

The present invention provides a composition including a condensation polyamide and a maleated polyolefin, or a reacted product of the composition. The condensation polyamide can include nylon 66 having an amine end group (AEG) index of is ≥65 and ≤130. An unpolished microtome-cut pellet formed from the composition or reacted product thereof subjected to toluene etching at 90° C. for 2 hours can have a surface that, as compared using a magnification of 3000× to 5000× (e.g., using a scanning electron microscope), is less pitted than an identical composition or reacted product thereof wherein the amine end group (AEG) index of the nylon 66 is <65. The AEG index of the nylon 66 in the composition or reacted product thereof can be any suitable AEG, such as ≥65 and ≤130 (i.e., ≥65 meq/kg and ≤130 meq/kg), or ≥80 and ≤125, ≥80 and ≤120, or less than or equal to 130 but greater than or equal to 60, 65, 70, 75, 80, 85, 90, 95, 100, 105, 110, 115, 120, 125, or 130.

When the composition or reacted product is formed into an impact test bar and tested at −30° C. according to ISO 179/2-1eA to form a −30° C. notched impact fractured surface, the composition or reacted product can have an S_{dr} measurement of ≥10% as obtained from a surface profilometry analysis of the −30° C. notched impact fractured surface, wherein S_{dr} represents the degree to which the actual surface area increases in comparison to a flat state, wherein a −30° C. impact strength (KJ/m²) of the composition or reacted product can be at least 40% higher at an identical tensile modulus (GPa) as compared to a composition including a condensation polyamide or reaction product thereof that does not have an S_{dr} measurement of ≥10% as obtained from a surface profilometry analysis of a −30° C. notched impact fractured surface thereof.

The composition or reacted product thereof of the present invention can include the condensation polyamide. The condensation polyamide can be at least 30 wt % of the composition. The condensation polyamide can be the predominant polyamide in the composition. The composition or reacted product thereof can include from ≥10 wt % to ≤50 wt % of maleated polyolefin, such as ≥15 wt % to ≤50 wt %, ≥15 wt % to ≤45 wt %, ≥20 wt % to ≤50 wt %, ≥20 wt % to ≤45 wt %, ≥20.5 wt % to ≤50 wt %, ≥21 wt % to ≤50 wt %, ≥21.5 wt % to ≤50 wt %, ≥22 wt % to ≤50 wt %, ≥22.5 wt % to ≤50 wt %, or less than or equal to 50 wt % but greater than or equal to 10 wt %, 11, 12, 13, 14, 15, 16, 17, 18, 19, 20, 21, 22, 23, 24, 25, 26, 27, 28, 29, 30, 35, 40, 41, 42, 43, 44, 45, 46, 47, 48, or 49%. The maleated polyolefin can include maleic anhydride grafted onto a polyolefin backbone. The maleated polyolefin can have a grafted maleic anhydride incorporation of ≥0.05 to ≤1.5 wt % based on total weight of the maleated polyolefin.

The condensation polyamide can be one or more polyamides that can be formed via condensation (e.g., via reaction of an amine and carboxylic acid group to form an amide and release water). The condensation polyamide can include any suitable one or more condensation polyamides. The condensation polyamide can include nylon 66, nylon 66/6T, nylon 66/6I, nylon 66/DI, or a combination thereof. The condensation polyamide can be nylon 66. The condensation polyamide can be nylon 66/DI. The condensation polyamide can be substantially free of polyamides (prior to being combined into the composition and combining with any other polyamides therein) other than one or more of nylon 66, nylon 66/6T, nylon 66/6I, and nylon 66/DI. The condensation polyamide can be nylon 66, and the condensation polymer (prior to being combined into the composition) can be substantially free of polyamides other than nylon 66. The condensation polyamide can be nylon 66/DI, and the condensation polyamide (prior to being combined into the composition) can be substantially free of polyamides other than nylon 66/DI. The condensation polyamide can be the predominant polyamide in the composition, such that the condensation polyamide has a higher concentration in the composition than any other polyamide in the composition. The condensation polyamide can have any suitable relative viscosity (RV), such as determined via a 8.4 wt % solution in 90 wt % formic acid method (e.g., ASTM D789), such as equal to or greater than 35, 40, or 45, or such as equal to or less than 100, 90, or 80, or such as less than or equal to 100 but equal to or greater than 35, 36, 37, 38, 39, 40, 41, 42, 43, 44, 45, 46, 47, 48, 49, 50, 55, 60, 65, 70, 75, 80, 85, 90, or 95, or such as 30-80, 35-75, or 42-50, or such as 35-100, 40-90, or 45-80. The condensation polyamide can form any suitable proportion of the composition, such as at least 30 wt %, 40, or at least 50 wt %, or 30-99.9 wt %, 60-99.9 wt %, or ≥40 to ≤50 wt %, or less than or equal to 99.9 wt % but greater than or equal to 30 wt %, 35, 40, 45, 50, 55, 60, 65, 70, 75, 80, 82, 84, 86, 88, 90, 92, 94, 95, 96, 97, 98, 99, or 99.5 wt %.

The nylon 66/6T can include 0.1 mol % to 99.9 mol % PA66, or 50 mol % to 99 mol %, or 80 mol % to 99 mol % PA66, or greater than or equal to 0.1 mol %, 0.5, 1, 2, 4, 8, 10, 15, 20, 25, 30, 35, 40, 45, 50, 55, 60, 65, 70, 75, 80, 90, 92, 94, 96, 98, or 99 mol % PA66. The “6T” portion can include a mole ratio of “6” to “T” of equal to or greater than 1:100, 5:95, 10:90, 20:80, 30:70, 40:60, 50:50, 60:40, 70:30, 80:20, 90:10, 95:5, or 100:1. The nylon 66/DI can include 0.1 mol % to 99.9 mol % PA66, or 50 mol % to 99 mol %, or 80 mol % to 99 mol % PA66, of less than 100:1 but greater than or equal to 0.1 mol %, 0.5, 1, 2, 4, 8, 10, 15, 20, 25, 30, 35, 40, 45, 50, 55, 60, 65, 70, 75, 80, 90, 92, 94, 96, 98, or 99 mol % PA66. The “DI” portion can include a mole ratio of “D” to “I” of less than 100:1 but greater than or equal to 1:100, 5:95, 10:90, 20:80, 30:70, 40:60, 50:50, 60:40, 70:30, 80:20, 90:10, 95:5, or 100:1. The nylon 66/6I can include 0.1 mol % to 99.9 mol % PA66, or 50 mol % to 99 mol %, or 80 mol % to 99 mol % PA66, of less than 100:1 but greater than or equal to 0.1 mol %, 0.5, 1, 2, 4, 8, 10, 15, 20, 25, 30, 35, 40, 45, 50, 55, 60, 65, 70, 75, 80, 90, 92, 94, 96, 98, or 99 mol % PA66. The “6I” portion can include a mole ratio of “6” to “I” of less than 100:1 but greater than or equal to 1:100, 5:95, 10:90, 20:80, 30:70, 40:60, 50:50, 60:40, 70:30, 80:20, 90:10, 95:5, or 100:1.

In various aspects, the composition can be free of additional polyamides beyond what is included in the condensation polyamide. In other aspects, the composition further includes an additional polyamide, in addition to the condensation polyamide, the additional polyamide including nylon 66, nylon 612, nylon 610, nylon 12, nylon 6, nylon 66/6T, nylon 66/6I, nylon 66/DI, nylon 66/D6, nylon 66/DT, nylon 66/610, nylon 66/612, nylon 11, nylon 46, nylon 69, nylon 1010, nylon 1212, nylon 6T/DT, nylon DT/DI, a polyamide copolymer, or a combination thereof. The additional polyamide can form any suitable proportion of the composition, such as >0 to ≤85 wt %, or less than or equal to 85 wt % but greater than or equal to 0.1 wt %, 0.5, 1, 2, 4, 6, 8, 10, 15, 20, 25, 30, 35, 40, 45, 50, 55, 60, 65, 70, or 75 wt %. The additional polyamide can be nylon 6. The composition can be free of nylon 6 (e.g., the composition can have a concentration of nylon 6 of 0 wt % to ≤1 wt %). The additional polyamide can be a nylon-6,6/MPMD-I copolymer.

The composition can optionally further include polycaproamide (N6), polyhexamethylene decanamide (N610), polyhexamethylene dodecanamide (N612), polyhexamethylene succinamide (N46), polyhexamethylene azelamide (N69), polydecamethylene sebacamide (N1010), polydodecamethylene dodecanamide (N1212), nylon 11 (N11), polylaurolactam (N12), nylon 6T/DT, nylon DT/DI, syndiotactic polystyrene (SPS), styrene-maleic anhydride (SMA), imidized styrene-maleic anhydride (SMI), or combinations thereof. The level of one or more of these additional components can be up to 50% by weight of the total composition, such as less than or equal to 50 wt % but greater than or equal to 0.1 wt %, 0.5, 1, 2, 4, 6, 8, 10, 15, 20, 25, 30, 35, 40, or 45 wt %.

In various aspects, the condensation polyamide is chosen from nylon 66, nylon 66/6T, nylon 66/6I, and a combination thereof, and the composition further includes a nylon-6,6/MPMD-I copolymer. The condensation polyamide can be nylon 66, and the composition can further include a nylon-6,6/MPMD-I copolymer. The condensation polyamide can be 30 wt % to 60 wt % of the composition, or less than or equal to 60 wt % but greater than or equal to 30 wt %, 35, 40, 45, 50, or 55 wt %. The nylon-6,6/MPMD-I copolymer can be a random copolymer. The nylon-6,6/MPMD-I copolymer can form any suitable proportion of the composition, such as ≥2 to ≤50 wt %, ≥25 to ≤35 wt %, >0.2 wt % to ≤10 wt %, or less than or equal to 50 wt % but greater than or equal to 0.2 wt %, 0.4, 0.6, 0.8, 1, 2, 3, 4, 5, 6, 8, 10, 12, 14, 16, 18, 20, 22, 24, 26, 28, 30, 32, 34, 36, 38, 40, 42, 44, 46, or 48 wt %.

The maleated polyolefin includes a polyolefin or polyacrylate backbone having pendant maleic anhydride groups grafted thereto. The polyolefin component can optionally be an ionomer. The polyolefin can be any suitable polyolefin polymer or copolymer. The polyolefin can include EPDM, ethylene-octene, polyethylene, polypropylene, or a combination thereof. In various aspects, the maleated polyolefin is free of EPDM. The maleated polyolefin can have any suitable grafted maleic anhydride incorporation, such as a grafted maleic anhydride incorporation of less than 10 wt %, or of 0.01 to 10 wt %, based on total weight of the maleated polyolefin, such as ≥0.1 to ≤1.4 wt %, ≥0.15 to ≤1.25 wt %, or less than or equal to 1.25 wt % but equal to or greater than 0.1 wt %, 0.2, 0.3, 0.4, 0.5, 0.6, 0.7, 0.8, 0.9, 1, 1.1, 1.2, or 1.3 wt %. The maleated polyolefin can have any suitable glass transition temperature (T_{g}), such as ≥−70° C. to ≤0° C., ≥−60° C. to ≤−20° C., ≥−60° C. to ≤−30° C., or less than or equal to 0° C. but greater than or equal to −70° C., −65, −60, −55, −50, −45, −40, −35, −30, −25, −20, −15, −10, or −5° C. The maleated polyolefin can form any suitable proportion of the composition, such as ≥15 wt % to ≤50 wt %, ≥15 wt % to ≤45 wt %, ≥20 wt % to ≤50 wt %, ≥20 wt % to ≤45 wt %, ≥20.5 wt % to ≤50 wt %, ≥21 wt % to ≤50 wt %, ≥21.5 wt % to ≤50 wt %, ≥22 wt % to ≤50 wt %, ≥22.5 wt % to ≤50 wt %, or less than or equal to 50 wt % but greater than or equal to 10 wt %, 11, 12, 13, 14, 15, 16, 17, 18, 19, 20, 21, 22, 23, 24, 25, 26, 27, 28, 29, 30, 35, 40, 41, 42, 43, 44, 45, 46, 47, 48, or 49%.

The maleated polyolefin can be any suitable maleic anhydride-grafted polyolefin. A variety of maleated polyolefins are commercially available. These may include, but are not limited to, AMPLIFY™ GR Functional Polymers or FUSABOND™ N216, commercially available from Dow Chemical Co. (Amplify™ GR 202, Amplify™ GR 208, Amplify™ GR 216, Amplify™ GR380), Exxelor™ Polymer Resins commercially available from ExxonMobil (Exxelor™ VA 1803, Exxelor™ VA 1840, Exxelor™ VA1202, Exxelor™ PO 1020, Exxelor™ PO 1015), ENGAGE™ 8100 Polyolefin Elastomer commercially available from Dow Elastomer, Bondyram® 7103 Maleic Anhydride-Modified Polyolefin Elastomer commercially available from Ram-On Industries LP, and the like. Table 1 lists non-limiting commercially available modified polyolefins.

TABLE 1
Commercially available modified polyolefins.

| | Commercial Manuf./Trade | Modification Level |
|---|---|---|
| Polyolefin | Name | (wt %) in Polyolefin |
| Polypropylene | ExxonMobil/Exxelor ™ VA1840 | 0.2-0.5 |
| Polypropylene | Ram-On Industries/Bondyram ® | <1 |
| | 7103 | |
| Very low-density | Dow Chemicals/Amplify ™ | 0.25-0.5 |
| Polyethylene (vLDPE) | GR208 | |
| Polypropylene | ExxonMobil/Exxelor ™ PO1015 | 0.25-0.5 |
| Ethylene alpha olefin | ExxonMobil/Exxelor ™ VA1202 | 0.5-1 |
| Modified ethylene | Dow Chemicals/FUSABOND ™ | 0.5-1 |
| copolymer | or Amplify ™ GR216 | |
| Pure Ethylene | ExxonMobil/Exxelor ™ VA1803 | 0.5-1 |
| Low-density | Dow Chemicals/Amplify ™ | >1 |
| Polyethylene (LDPE) | GR202 | |
| Maleic anhydride- | Mitsui TAFMER ™ high- | ~1 |
| modified polyolefin | performance elastomer | |
| Very low density | OREVAC ® SK functional | — |
| polyethylene | polymer | |

In Table 1, the term “Modification Level (wt %) in Polyolefin” means the functionalized level in the polyolefin tested. For example, in the first row of Table 1, polypropylene with 0.2-0.5 wt % modification level means it is a modified polyolefin having 0.2-0.5% grafted maleic anhydride content.

In various aspects, the composition can include glass fibers or other glass reinforcements, or the composition can be substantially free of glass fibers or other glass reinforcements. The composition can include ≥1 wt % to ≤50 wt % glass fibers or other reinforcing fibers, ≥10 wt % to ≤42 wt %, ≥10 wt % to ≤35 wt %, ≥15 wt % to ≤30 wt %, ≥0 wt % to ≤2 wt %, or less than or equal to 50 wt % but equal to or greater than 5 wt %, 10, 15, 20, 25, 30, 35, 40, or 45 wt %.

In various aspects, the condensation polyamide has an AEG of ≥65 milliequivalents per kg (meq/kg) and ≤130 meq/kg; or the maleated polyolefin, or domains thereof, is/are uniformly distributed in the condensation polyamide or in the composition; or the condensation polyamide has an RV of at least 35; or the condensation polyamide is chosen from nylon 66, nylon 66/6T, nylon 66/6I, nylon 66/DI, and a combination thereof; or a combination thereof.

The composition including the condensation polyamide and the maleated polyolefin, or the reacted product thereof, can be a compounded composition including one or more other components. The one or more components other than the condensation polyamide, the maleated polyolefin, and reaction products thereof, can be any suitable one or more other components, such as including a modified polyphenylene ether, an impact modifier, a flame retardant, a lubricant (e.g., CRODAMIDE™), a chain extender, a heat stabilizer, a colorant additive, a filler, a conductive fiber, glass fibers, another polyamide other than the condensation polyamide, or a combination thereof. The one or more other components can include a chain extender including a dialcohol, a bis-epoxide, a polymer including epoxide functional groups, a polymer including anhydride functional groups, a bis-N-acyl bis-caprolactam, a diphenyl carbonate, a bisoxazoline, an oxazolinone, a diisocyanate, an organic phosphite, a bis-ketenimine, a dianhydride, a carbodiimide, a polymer including carbodiimide functionality, or a combination thereof. Examples of flame retardants can include Exolit® OP 1080P, Exolit® OP 1314, Exolit® OP 1400, and the like. Exolit® FR additives are commercially available from Clariant. Examples of colorants can include commercial products available in the thermoplastics industry, such as, Black MB Colorant (e.g., carbon black or Nigrosine black dye). Examples of other additives, such as heat stabilizer, chain extenders, cross linkers, may include copper or organic-based such as ZeMac™ amorphous copolymers, Irganox® B1171, Irganox® B1098, Bruggolen™ TP-H1802, Bruggolen™ M1251, and the like. For example, Irganox® B1171 is a commercial polymer additive product of BASF. The ZeMac™ amorphous copolymers are commercially available from Vertellus™ (www.vertellus.com).

The one or more other components can include a chain extender. The chain extender can be capable of reacting with the amine and/or acid terminal groups of the condensation polyamide and/or of the reaction product thereof with the maleated polyolefin, thereby connecting two polyamide chains. The chain extender can be any suitable chain extender, such as a dialcohol (e.g., ethylene glycol, propanediol, butanediol, hexanediol, or hydroquinone bis(hydroxyethyl)ether), a bis-epoxide (e.g., bisphenol A diglycidyl ether), polymers having epoxide functional groups (e.g., as pendant and/or terminal functional groups), polymers including anhydride functional groups, bis-N-acyl bis-caprolactams (e.g., isophthaloyl bis-caprolactam (IBS), adipoyl bis-caprolactam (ABC), or terephthaloyl bis-caprolactam (TBC)), diphenyl carbonates, bisoxazolines, oxazolinones, diisocyanates, organic phosphites (triphenyl phosphite, caprolactam phosphite), bis-ketenimines, or dianhydrides. The chain extender can be a polymer including anhydride functional groups, such as a maleic anhydride-polyolefin copolymer (e.g., an alternating copolymer of maleic anhydride and ethylene). For end-uses that require hydrolysis resistance, chain extenders that are known to improve hydrolysis resistance are preferred. The chain extender can be any suitable proportion of the composition or reacted product thereof, such as ≥0.05 to ≤5 wt % or ≥0.05 to ≤2 wt %, or less than or equal to 5 wt % but greater than or equal to 0.05 wt %, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.2, 4.4, 4.6, or 4.8 wt %.

The composition including the condensation polyamide and maleated polyolefin, or the reacted product thereof, can have any suitable melt strength. For example, the composition or reacted product thereof can exhibit a melt strength of ≥0.3 to ≤1.0 N in a Rheotens test conducted at 270° C. to 290° C., a moisture level of 0.03-0.1%, and an extrusion speed of 300-700 mm/s, or a melt strength of ≥0.8 to ≤1.0 N, or a melt strength of less than or equal to 1 N and greater than or equal to 0.3, 0.35, 0.4, 0.45, 0.5, 0.55, 0.6, 0.65, 0.7, 0.75, 0.8, 0.85, 0.9, or 0.95 N.

The maleated polyolefin, domains thereof, or reaction products thereof with the condensation polyamide, can have any suitable distribution in the condensation polyamide (and in any additional polyamides present) or in the composition. For example, the maleated polyolefin, reaction product thereof, or domains thereof, can have a uniform or homogeneous distribution in the condensation polyamide (and any additional polyamides present) or in the composition. The uniformity or homogeneity can be present on a molecular level, such that the molecules of the maleated polyolefin or reaction product thereof are homogeneously distributed therein. The maleated polyolefin or reaction product thereof can form domains within the condensation polymer (and any other polyamides present) or within the composition; in some aspects, the maleated polyolefin or reaction product thereof can be at least partially immiscible with the condensation polymer. For example, the condensation polymer (and any other polyamides present), or all polymeric components other than the maleated polyolefin, or the remainder of the composition, can form a continuous phase, and the maleated polyolefin or a reaction product thereof can form a discontinuous phase (domains) therein, such that the maleated polyolefin or reaction product thereof primarily resides in islands in a condensation polyamide sea. In various aspects, articles described herein, formed from the composition that includes the condensation polyamide and the maleated polyolefin, the reacted product thereof, or a combination thereof, can include a uniform or homogeneous distribution of the maleated polyolefin, reaction products thereof, and/or domains of the maleated polyolefin or reaction products thereof.

### Reacted Product of the Composition Including a Condensation Polyamide and a Maleated Polyolefin.

The present invention provides a reacted product that is a reaction product of the composition including the condensation polyamide and the maleated polyolefin. The reacted product of the composition can include one or more products formed via reaction of the condensation polyamide and the maleated polyolefin, such as a polyamide-polyolefin copolymer formed from at least partial reaction of the condensation polyamide and the maleated polyolefin.

The reacted product can include the composition including the condensation polyamide and the maleated polyolefin wherein any suitable proportion of the condensation polyamide has reacted with the maleated polyolefin. For example, the reacted product can include the polyamide-polyolefin copolymer in a concentration range of ≥50 to ≤7500 ppmw, ≥100 to ≤4900 ppmw, ≥225 to ≤3750 ppmw, or less than or equal to 7500 ppmw but greater than or equal to 50, 100, 250, 500, 750, 1,000, 1,500, 2,000, 2,500, 3,000, 3,500, 4,000, 4,500, 5,000, 6,000, 7,000, or 8,000 ppmw. In some aspects, the amount of polyamide-polyolefin copolymer can be calculated by multiplying the concentration of the maleated polyolefin with the modification level of the maleated polyolefin. For example, for a reacted product made from 80:20 (wt:wt) polyamide:modified polyolefin having 0.5 wt. % grafted (e.g.: maleated) modification, the total reacted polyamide-polyolefin modification functionality in the sample (assuming all grafted maleic anhydride reacts, which may not occur) can be calculated as (0.20)*(0.005)*106=1000 ppmw.

Without limiting the scope of the disclosure with a recitation of a theoretical mechanism, the generalized chemical reaction schematically represented in Scheme 1 is one approach to understand the interaction of a maleated olefin copolymer with a polyamide.

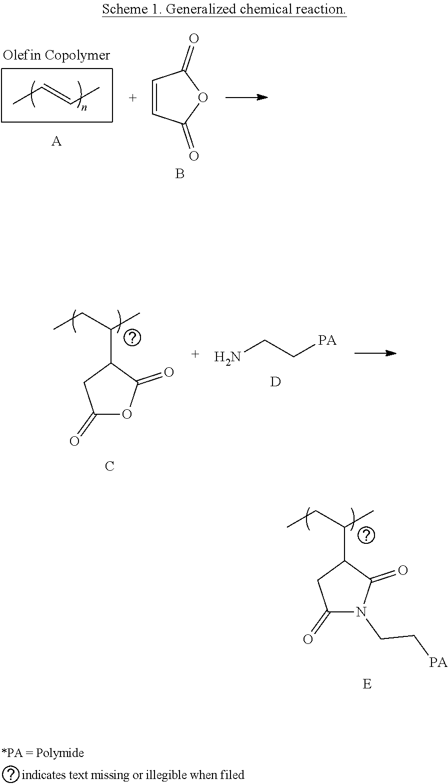

Structure D in Scheme 1 represents the condensation polyamide. Structure A in Scheme 1 represents the polyolefin, and Structure C represents the maleated polyolefin (a maleic anhydride-grafted polyolefin). The terms “degree of maleation” or “modification level”, as used interchangeably herein, means the extent of which the olefin copolymer (structure A) has been reacted with maleic anhydride (structure B). Structure E represents a reaction product formed from reaction of the condensation polyamide and the maleated polyolefin.

Article Formed from the Composition or the Reacted Product Thereof.

The present disclosure provides an article formed from the composition including the condensation polyamide and the maleated polyolefin, from the reacted product of the composition, or a combination thereof. The article can be resistant to cold-temperature cracking. The article can be a molded article or an extruded article. The article can include glass fibers, or the article can be substantially free of glass fibers and/or other reinforcing fibers. The article can be produced using any suitable method, such as using blow molding (pressure and suction), extrusion, compression molding, thermoforming, injection molding, or other industrial processes.

In various aspects, the article can be a conduit (e.g., a pipe or tube). The conduit can be chosen from a conduit that is rigid, flexible, curved, bent, serpentine, partially corrugated, fully corrugated, and a combination thereof. The conduit can have any suitable cross-section, such as round, oval, oblong, square, rectangle, triangle, star, polygonal, and a combination thereof. The conduit can be an extruded conduit.

In various aspects, the article can be an extruded sheet. The article can be a folded extruded sheet, or an unfolded extruded sheet. The sheet can be a film. The sheet can have any suitable thickness, such as a thickness of 0.01 mm to 10 mm, or 0.1 mm to 10 mm, or 0.2 mm to 6 mm, or less than or equal to 10 mm but greater than or equal to 0.01 mm, 0.02, 0.04, 0.06, 0.08, 0.1, 0.15, 0.2, 0.4, 0.6, 0.8, 1, 1.5, 2, 2.5, 3, 3.5, 4, 4.5, 5, 5.5, 6, 6.5, 7, 7.5, 8, 8.5, 9, or 9.5 mm. The sheet can have any suitable width-to-thickness ratio, such as at least 10, or at least 20, or ≥10 to ≤40,000, or ≥20 to ≤20,000, or greater than or equal to 10, 20, 40, 60, 80, 100, 150, 200, 250, 500, 750, 1,000, 1,500, 2,000, 2,500, 5,000, 10,000, 15,000, 20,000, 25,000, 30,000, 35,000, or 40,000. The sheet can exhibit an impact resistance (e.g., as measured using a heavy duty impact tester such as BYK-Gardner USA Model 1120 or 5545) in kJ/m² that is within 10% of an impact resistance of a polycarbonate sheet of like thickness under like impact resistance testing conditions, such as within 1%, 2, 3, 4, 5, 6, 7, 8, 9, or within 10%.

The article can be any suitable article. For example, the article can be an automotive article, a building construction article, a conveyor system article, an article for use in the petrochemical industry, an internal or external enclosure for telecommunication equipment, or another article for use in an application seeking metal parts replacement, such as for weight-shedding without or with minimal performance compromise. The article can include a film, a mat, a liner, a flooring, a construction material, a pad, a shutter, a panel, a belt, a slide, an enclosure, a vehicle component, an architectural component, or a combination thereof. The article can include a slip sheet, a die cutting mat, a silo liner, a die cutting mat, a truck bed liner, flooring (e.g., for residential, commercial, and/or transportation end uses), a construction material (e.g., roofing shingles, roofing panels, siding shingles, roofing shingles and underlayments for any of the foregoing), a ground pad (e.g., pads for rotating equipment and structures), a construction envelope system (e.g., residential or commercial construction envelope systems), a storm-resistant shutter (e.g., hurricane and tornado shutters), a hail-resistant panel, a geo-textile (e.g., pond liner), a conveying system component (e.g., a belt or slide), an electronic equipment enclosure, or a combination thereof.

### Method of Making the Composition or the Reacted Product Thereof.

The present disclosure provides a method of making the composition including the condensation polyamide and the maleated polyolefin, of making the reacted product of the composition, or a combination thereof. The method includes combining the condensation polyamide and the maleated polyolefin to form the composition, the reacted product thereof, or a combination thereof.

In various aspects, the method can include combining the condensation polyamide and the maleated polyolefin (e.g., and allowing the two to at least partially react to form a reacted product of the composition) before adding a chain extender thereto. In other aspects, the method of making the composition including the condensation polyamide and the maleated polyolefin or the reacted product thereof, includes combining the condensation polyamide, the maleated polyolein, and the chain extender at once without allowing any extra time for the condensation polyamide and the maleated polyolefin to react. In other aspects, the composition including the condensation polyamide and the maleated polyolefin, or the reacted product thereof, is substantially free of chain extender.

The method can include providing to a first compounder extruder zone a feed including the condensation polyamide and the maleated polyolefin. The method can include maintaining the first compounder extruder zone conditions sufficient to obtain a first compounded polyamide melt inside the first compounder extruder zone. The method can include introducing a chain extender to the first compounded polyamide melt in a second compounder extruder zone. The method can also include maintaining the second compounder extruder zone conditions sufficient to obtain a second compounded polyamide melt inside the second compounder extruder zone, wherein the second compounded polyamide melt is the composition including the condensation polyamide and the maleated polyolefin or the combination thereof. The second compounder extruder zone is downstream of the first compounder extruder zone and can be any suitable distance from the first compounder extruder zone; the chain extender can be added at any suitable location along the length of the screw extruder barrel. The temperature of the compounded polyamide melts can be any suitable temperature, such as 240 to 320° C., 240 to 300° C., 240 to 265° C., or less than or equal to 320° C. and greater than or equal to 240° C., 250, 260, 270, 280, 290, 300, or 310° C.

The first compounder extruder zone can be substantially free of the chain extender, and/or of any chain extender. The chain extender can be ≥0.05 to ≤5 wt % of the second compounded polyamide melt. The method can further include producing an article from the second compounded polyamide melt; for example, the method can include producing extrudate from the second compounded polyamide melt or producing a molded article from the second compounded polyamide melt.

An extruder used to make the composition including the condensation polyamide and the maleated polyolefin or the reacted product thereof, can be a screw extruder (e.g., a single screw extruder, a vented twin-screw extruder, or an unvented twin-screw extruder). A barrel of the screw extruder can include the first compounder extruder zone and the second compounder extruder zone. Providing the feed to the first compounder extrusion zone can include providing the feed to a feed inlet of the barrel. The screw extruder can have a suitable diameter, such as a diameter of 10-30 mm, such as 18-26 mm, such as 10 mm, 11, 12, 13, 14, 15, 16, 17, 18, 19, 20, 22, 24, 26, 28, or 30 mm. The L/D ratio of the extruder can be any suitable ratio, such as 30-70, or 40-56.

In various aspects, the chain extender can be introduced to the second compounder extruder zone in the barrel a suitable distance away from the feed inlet. For example, the chain extender can be introduced to the second compounder extruder zone at least ¼ of the length of the barrel from the feed inlet of the barrel. The chain extender can be introduced to the second compounder extruder zone at least ½ of the length of the barrel from the feed inlet of the barrel. The chain extender can be introduced to the second compounder extruder zone at least ¾ of the length of the barrel from the feed inlet of the barrel. The chain extender can be introduced to the second compounder extruder zone sufficiently far from an outlet of the barrel to provide mixing of the chain extender with the first compounded polyamide melt to form the second compounded polyamide melt, and equal to or greater than ¼ of the length of the barrel from the feed inlet of the barrel, or ½, ¾, or more. The chain extender can be introduced to the second compounder extruder zone sufficiently far from an outlet of the barrel to provide mixing of the chain extender with the first compounded polyamide melt to form the second compounded polyamide melt, and equal to or greater than 20% of the length of the barrel from the feed inlet of the barrel, or 30%, 40, 50, 60, 70, 80, 90, or 95% or more of the length of the barrel from the feed inlet of the barrel.

In various aspects, the introducing of the chain extender to the first compounded polyamide melt in the second compounder extruder zone can include introducing the chain extender to the first compounded polyamide melt after a certain weight percentage of the maleated polyolefin has incorporated into the condensation polyamide or into the composition. Incorporation into the condensation polyamide or into the composition can include homogeneous blending of the chain extender with the condensation polyamide or the composition (e.g., on a molecular level, or of domains of the maleated polyolefin or a reaction product thereof), formation of a reaction product of the maleated polyolefin (e.g., with the condensation polyamide), formation of domains of the maleated polyolefin or a reaction product thereof in the condensation polyamide or the composition, or a combination thereof. The introducing of the chain extender to the first compounded polyamide melt in the second compounder extruder zone can include introducing the chain extender to the first compounded polyamide melt after at least 50 wt % of the maleated polyolefin fed has incorporated into the condensation polyamide, or greater than or equal to 50%, 60%, 70%, 80%, 90%, greater than or equal to 95%, or after about 100% of the maleated polyolefin has incorporated into the condensation polyamide.

The present disclosure provides a method of extrusion of a polyamide resin. The method can include providing the composition including the condensation polyamide and the maleated polyolefin, the reacted product thereof, or a combination thereof, to a feed zone of an extruder. The method can include maintaining extruder barrel conditions sufficiently to obtain a polyamide resin melt inside the extruder. The method can also include producing extrudate from the extruder while optionally recovering vapor from the extruder via a vacuum draw.

Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com website), the skilled person can make suitable articles of any conceivable shape and appearance using the composition and/or reacted composition of the present disclosure, such as from the second compounded polyamide melt.

### Industrial Utility

The industrial applicability of the disclosed polyamide resin compositions and reacted products thereof can be realized in the processes of making articles by blow molding (pressure or suction), extrusion, compression molding, thermoforming, injection molding, and other such industrial processes. The improved impact resistance and ductility of these polyamide resins, especially at the sub-zero operating conditions, can make these resins suitable for automotive, building construction, conveyer systems, petrochemicals, internal and external enclosures for telecommunications equipment, and many other applications seeking metal parts replacement for weight-shedding without the performance compromise. Articles made from the disclosed polyamide compositions will find applications in a variety of industries for their light-weight, durability, and improved impact resistance/ductility properties, such as improved impact toughness properties measured at temperatures below 0° C. (cold impact resistance).

### EXAMPLES

Various aspects of the present invention can be better understood by reference to the following Examples which are offered by way of illustration. The present invention is not limited to the Examples given herein.

### General Procedure for Producing Compounded Material.

A twin-screw vented extruder having a co-rotating screw with an L/D ratio of 50 is used for compounding. The unit has one main feeder and at least three side feeders. A feed rate of 1 kg/hr is used. The twin-screw co-rotating/turning is set to 1000 RPM to provide high shear for effective compounding. The total compounder throughput is 15 kg/hr.

The compounding unit has at least three vent ports: one atmospheric port and two vacuum ports. A knock-out pot was provided in this operation. The rotating twin screws impart forward momentum to the heated mass inside the barrel. The barrel is heated along its length to melt the polymer. The temperature was 280° C. for the nylon 66 Examples.

The processing section of the twin-screw compounder is set up to suit various process needs and to allow a wide variety of processes, such as compounding processes. Polymer, fillers, and additives (as described below) are continuously fed into the first barrel section of the twin screw using a metering feeder. The products are conveyed along the screw and are melted and mixed by kneading elements in the plastification section of the barrel. The polymer then travels along to a side port where fillers (if used, as described below), such as glass fiber. The polymer then travels on to degassing zones and from there to a pressure build zone where it then exits the die via an at least 3-mm hole as a lace. The cast lace is fed into a water bath to cool and to enable it to be cut into chips via a pelletizer. The unit is able to withstand at least 70 bar die pressure. A die with four holes, each of 3 mm diameter, is used for pelletizing.

The compounded, cylindrical extruded pellet having a diameter of 3 mm and a length of 4 mm is produced using the above equipment. The moisture content of the pelletized material is <0.2 wt. %.

### Materials Used in Examples.

Feedstock PA66 polyamide, as used herein, is a commercially available INVISTA nylon 66 (or N66) grade under the Tradename INVISTA™ U4500 or U4800 polyamide resin. The PA66 has standard RV range of 80 to 240, for example, 42-50.

The PA66/DI used in the Examples has a relative viscosity (RV) of 45. In the Example compositions containing PA66/DI, the recycled amine content is >0.2 wt. % and ≤10 wt. % of the total composition, wherein the DI content is 8 wt. % of the total composition.

Other non-limiting co-polyamides suitable for use in place of the PA66/DI used in the present examples include 66/D6, 66/DT, 6T/DT, 66/610, 66/612, and such.

### Test Methods Used in the Examples

ASTM D789: Relative viscosity (RV) measurement method.

ISO 527: Tensile Test conducted at room temperature.

ISO 179/2-1eA: Notched Charpy Impact Test. Tests were conducted at −30° C.

An improvement in melt strength is evidenced by an increase in the R* value which is defined as the ratio of the low shear rate viscosity at 1 sec.⁻¹ of the composition to the high shear rate viscosity at 100 sec.⁻¹, at a predetermined optimum processing temperature: R*=(viscosity at 1 sec⁻¹)/(viscosity at 100 sec⁻¹). The concept of melt viscosity and R* value is further discussed in U.S. Pat. No. 5,576,387 (assigned to Sabic Innovative Plastics) and Abolins et al. U.S. Pat. No. 4,900,786.

Another way to determine the melt strength for polymers is by using Rheotens test method. In this method, a vertical strand of a polymer melt is drawn at a constant extension rate. The draw force (usually measured in centi Newtons (CN), or Newtons (N)) needed to elongate the strand is measured. Such Rheotens test device is commercially available from GÖTTFERT (www.goettfert.com) for determining various rheological properties of plastics and rubbers, for example, melt strength, melt elasticity, tensile strength measurements, etc. The melt strand take away speeds (or extension rates) during the Rheotens measurement can range between 0 to 1200 mm/sec. The polymer melt strength is generally described in centi Newtons (cN) as determined using a Rheotens device, for example a Goettfert Rheotens tester, at specimen-dependent particular temperature and at certain mm/sec of take away speed.

Scanning Electron Microscope (SEM) analysis: The SEM analysis was performed using a JSM-7200F field emission scanning electron microscope for the samples prepared in the Examples. For analysis of etching effects, samples were prepared by microtoming at room temperature. The term “microtoming” as used herein means cutting extremely thin slices of material, known as sections, for microscopy analysis. The sectioned specimens were then immersed in toluene at 90° C. for 2 hrs.

Determination of the sample toughness and tensile elongation when exposed to mechanical stress (by fracturing the specimen) was performed to understand correlations between energy dissipation in the polymer matrix and the observed microstructural characteristics. Crack deflection for the tested samples was qualitatively determined by observing the % roughness on fractured surfaces. Cavitation (porosity) effects were observed by a quantitative determination of the stress whitening zone thicknesses for tested samples along with 2D measurement of porosity area fraction below the fracture surface in the bulk material. Shear yielding (deformation) effects manifested in pore elongation were quantitatively determined by measuring the aspect ratio (ratio of major to minor axis of a fitted ellipse) of porosity.

The test bar specimens for impact fracture testing were formed into an impact test bar and tested at −30° C. according to ISO 179/2-1eA to form a −30° C. notched impact fractured surface.

For tensile testing at room temperature, test bar specimens were prepared and tested according to the ISO 527 test method.

As used in the Examples, “room temperature” means the ambient temperature under which testing was performed, which was generally about 23° C. (e.g., about 19° C. to about 27° C.).

### Examples 1(A-K). Compounded Polyamide Specimens

Table 2 gives compositional ranges for the several polyamide samples that were compounded using the general procedure detailed above.

TABLE 2
Polyamide Samples A-K (Ex. 1A-1K).

| Component | | | | | | | | | | | |
|---|---|---|---|---|---|---|---|---|---|---|---|
| (wt. %) | A | B | C | D | E | F | G | H | I | J | K |
| 48 RV PA66 (U4800) | 73.5 | 58.5 | — | — | — | — | — | — | — | — | — |
| High AEG PA66 (45 RV) (INVISTA | — | — | 73.5 | 54.55 | 74 | 42.3 | 77 | 45 | 45 | 79 | 48.1 |
| U4591) | | | | | | | | | | | |
| PA66/DI (45 RV) | — | — | — | — | — | 30 | — | 30 | 29 | — | 30.9 |
| Maleated polyolefin (DOW | 25 | 25 | 25 | 25 | 25 | 25 | 22 | 22.5 | 25 | 20 | 20 |
| FUSABOND ™ N216) | | | | | | | | | | | |
| PA610 | — | — | — | 18 | — | — | — | — | — | — | — |
| PA612 | — | 15 | — | — | — | — | — | — | — | — | — |
| Black MB Colorant (e.g.: carbon black or | 0.6 | 0.6 | 0.6 | 1.0 | — | 1.0 | — | 1.5 | — | — | — |
| Nigrosine black dye) | | | | | | | | | | | |
| Heat stabilizer (e.g., Cu-based or organic | — | — | — | 1.2 | 1.0 | 1.2 | — | — | — | — | — |
| based such as Irganox ® B1171) | | | | | | | | | | | |
| Chain extender (e.g., ZeMac ™ E60) | — | — | — | 0.25 | — | — | — | — | — | — | — |
| Antioxidant (BASF Irganox ® or | | | | | | | 1.0 | 1.0 | 1.0 | 1.0 | 1.0 |
| Americhem) | | | | | | | | | | | |
| Hydrolysis stabilizer (e.g., Stabaxol | — | — | — | — | — | 0.5 | — | — | — | — | — |
| P100) | | | | | | | | | | | |
| Zytel ® FE7108 | 0.9 | 0.9 | 0.9 | — | — | — | — | — | — | — | — |
| TOTAL | 100 | 100 | 100 | 100 | 100 | 100 | 100 | 100 | 100 | 100 | 100 |

The melt strength is determined using a Rheotens test method. For example, the melt strength for the compounded polymer resin of the Ex. 1E or 1F specimens is measured to be in the 0.3-1.0 Newton range (typically 0.7 N) at 270-290° C. (typically 280° C.) test temperature for polymer samples having 0.03-0.1 wt % moisture (typically 0.06 wt %) and at 300-700 mm/s extrusion rate (typically 500 mm/s) or strand take away speed.

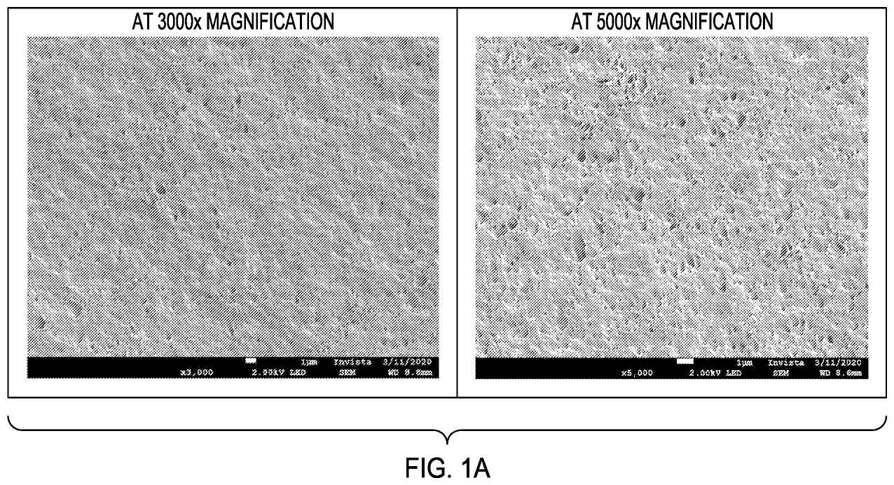

FIGS. 1A-B show the SEM visual representation of samples at 3000× (left-side of FIGS. 1A-B) and 5000× (right-side of FIGS. 1A-B) magnifications. The Ex. 1A specimen is shown in FIG. 1A and the Ex. 1E specimen is shown in FIG. 1B.

The 2-hour immersion of the pellet microtomes in toluene at 90° C. was observed to be effective to show differences in the polymer structure by SEM analysis. Toluene appeared to etch out or dissolve out loosely bonded maleated polyolefin portions from the polymer matrix. It is evidenced by the pitted (or hollowed out) 1-micron or less microstructures in FIG. 1A for the Ex. 1A specimen, which contained 25 wt. % maleated polyolefin component in the regular PA66 matrix.

The hollowed-out microstructures were not prevalent in FIG. 1B for the Ex. 1E specimen that contained about 73.5 wt. % high AEG PA66 and about 25 wt. % maleated polyolefin. FIG. 1B shows lesser signs of maleated polyolefin dissolution in toluene, possibly due to more imide linkages. The Ex. 1E specimen exhibited significant “smearing effect” during microtome as evidenced by the vertically inclined smeared bands visible in FIG. 1B.

The SEM images shown in FIG. 1A corresponding to the Ex. 1A specimen and FIG. 1B corresponding to the Ex. 1E specimen were further processed to assess the surface porosity that was visible via the toluene etching method at 90° C. for 2 hrs. It was observed that the toluene-etched surface porosity for the Ex. 1E specimen shown in FIG. 1B was of the order of less than one-half of that for the Ex. 1A specimen shown in FIG. 1A. Though not bound by any theory, this may be indicative of lesser sign of maleated polyolefin dissolution in toluene possibly due to more imide linkages in the case of Ex. 1E compared to that for Ex. 1A. A higher toluene-etched surface porosity for Ex. 1A versus that for Ex. 1E may indicate more extraction of maleated polyolefin from its dissolution in the etching solvent.

### Examples 2A-C. Sample Toughness Determination (by Fracturing the Specimen)

In addition to three representative polyamide test specimens of Examples 1A, 1E, and 1F, three commercially available polyamide samples labeled Samples 2A-C were analyzed. The properties of these six test specimens are given in Table 3A below.

TABLE 3A
Test Specimens for toughness determination under fracture conditions.

| Sample ID | 1A | 1E | 1F | 2A | 2B | 2C |
|---|---|---|---|---|---|---|
| Material class | PA66 | PA66 | PA66 | Commercial PA12 | Commercial PA612 | Commercial High |
| | | | | (Extrusion Grade) | (Extrusion Grade) | Tough PA66 |
| Moisture absorption, at | 2.1 | 2.2 | 2.0 | 0.6 | 1.2 | 2.0 |
| 50% RH (%) | | | | | | |
| Tensile strength, DAM | 47 | 46 | 45 | 41 | 54 | 50 |
| (MPa) | | | | | | |
| Elongation @ break, | 122 | 149 | 123 | 163 | 20 | 45 |
| DAM (%) | | | | | | |
| Tensile modulus, DAM | 1.53 | 1.47 | 1.20 | 0.96 | 1.97 | 1.78 |
| (GPa) | | | | | | |
| 23° C. Notched charpy | 102 | 107 | 111 | 88 | 43 | 72 |
| impact, DAM (kJ/m²) | | | | | | |
| −30° C. Notched charpy | 47 | 90 | 85 | 87 | 15 | 33 |
| impact, DAM (kJ/m²) | | | | | | |

RH-Relative Humidity;
DAM-Dry as Molded

### Fractured Surface Roughness by −30° C. Notched Impact Test.

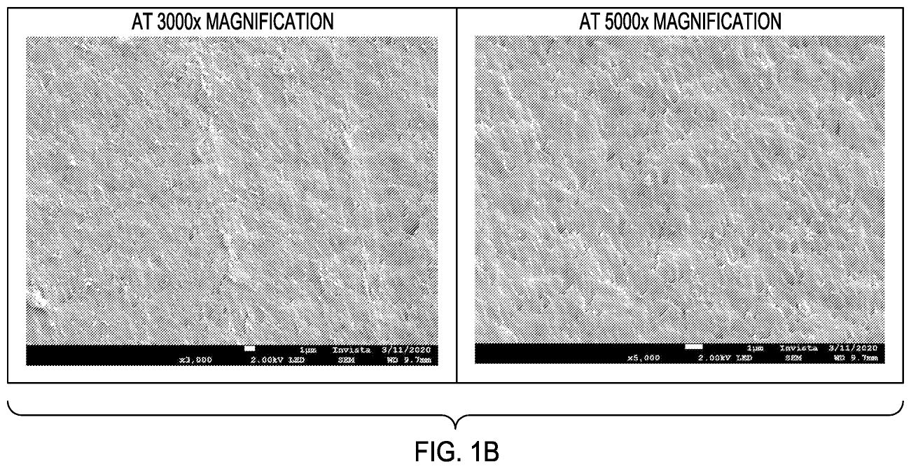

The SEM analysis images in FIGS. 2A-F show differences in surface roughness observed for the fractured surfaces from impact bars tested at −30° C. For all examples shown in FIG. 2A-F, the surface notch was on the left-side and the fracture path was from left to right.

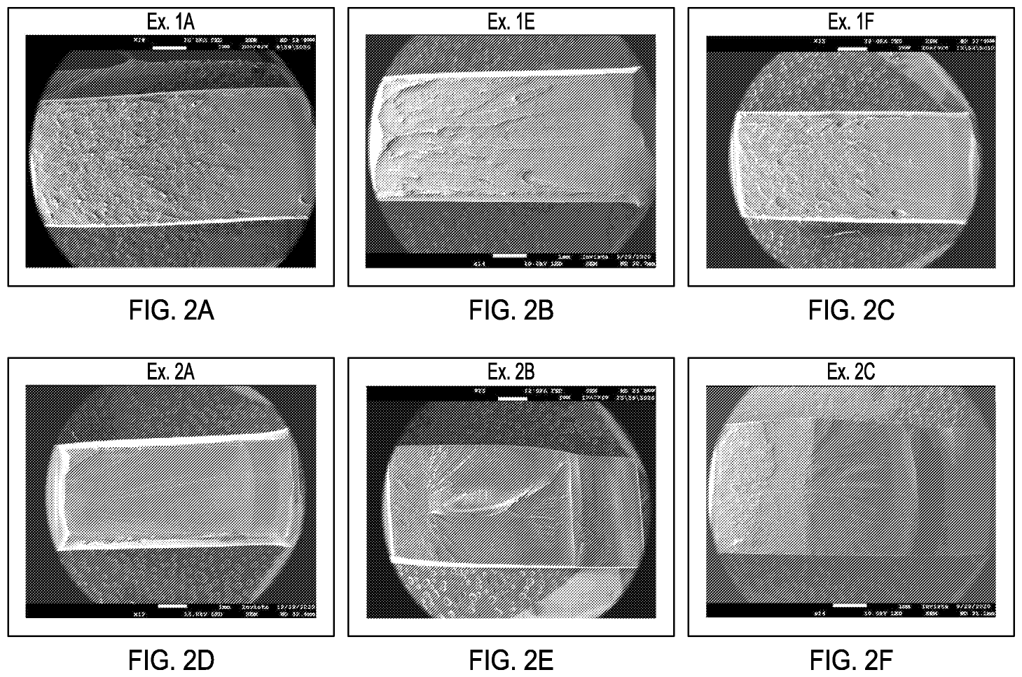

The −30° C. notched impact fractured surfaces were further analyzed using surface profilometry. The 3-dimensional profile images analyzed for roughness measurements are shown in FIGS. 3A-D. The surface profilometry analysis yielded the Table 3B quantitative data for the analyzed specimens.

TABLE 3B
Surface profilometry analysis.

| Sample ID | Sₐ (microns) | S_{dr} (%) | FIG. |
|---|---|---|---|
| 1A | 25.93 | 8.4 | FIG. 3A |
| 1E | 21.78 | 14.0 | FIG. 3B |
| 2B | 17.82 | 10.7 | FIG. 3C |
| 2C | 20.32 | 6.3 | FIG. 3D |

In Table 3A, the term “Sa” was measured in microns and defined as an arithmetic mean of the peak heights over the scanned surface. The term “S_{dr}” was measured as % and defined as the degree to which the actual surface area increases in comparison to the flat state. For example, an “S_{dr}” value of 0% means an entirely flat surface.

The measured “S_{dr}” values of the −30° C. notched impact fractured surfaces show the specimen order: 2C <1A <2B<1E.

The highest “S_{dr}” value of 14% for the Ex. 1E specimen was indicative of a rougher fractured surface in comparison to the others analyzed. Generally, and not bound by any theory, a rougher fracture surface morphology may be a sign of more impact energy dissipation due to crack deflection, increasing the material's ability to withstand a greater impact force prior to fracture.

Representative polyamide test specimens of Examples 1G, 1H, and 1I were analyzed. The properties of these test specimens are given in Table 3C.

TABLE 3C
Test specimens for toughness determination
under fracture conditions.

| Sample ID | 1G | 1H | 1I |
|---|---|---|---|
| Material class | PA66 | PA66 | PA66 |
| Tensile strength, DAM (MPa) | 50 | 47 | 48 |
| Elongation @ break, DAM (%) | 124 | 113 | 137 |
| Tensile modulus, DAM (GPa) | 1.56 | 1.52 | 1.41 |
| 23° C. Notched charpy impact, | 101 | 99 | 104 |
| DAM (kJ/m²) | | | |
| −30° C. Notched charpy impact, | 74 | 73 | 96 |
| DAM (kJ/m²) | | | |

RH - Relative Humidity;
DAM - Dry as Molded

### Stress Whitening Determination.

Standard impact test specimens were machined per the ISO 179/2-1eA test method. All samples were impact tested at −30° C. per ISO 179/2-1eA test method.

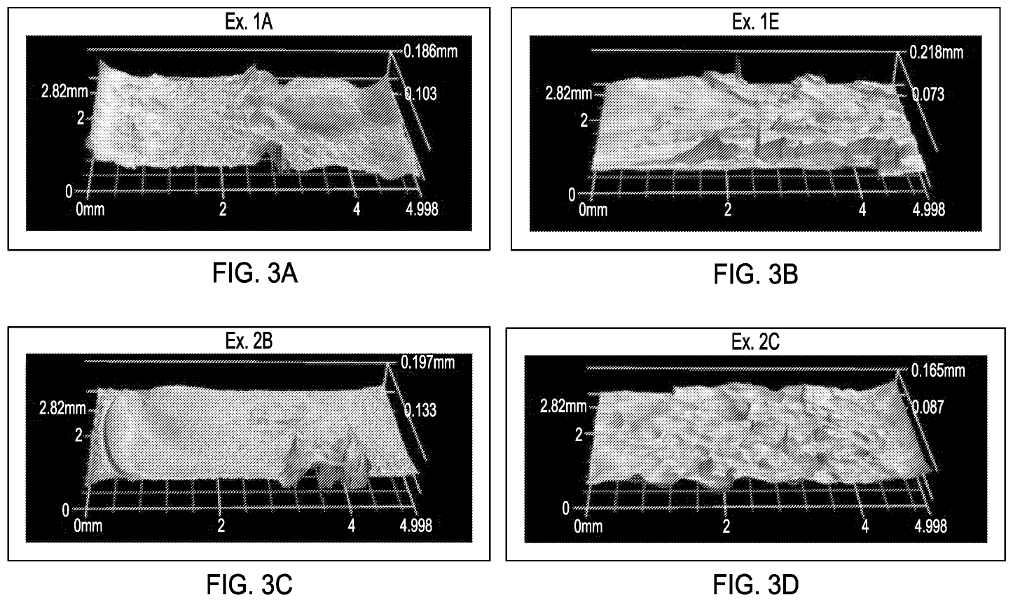

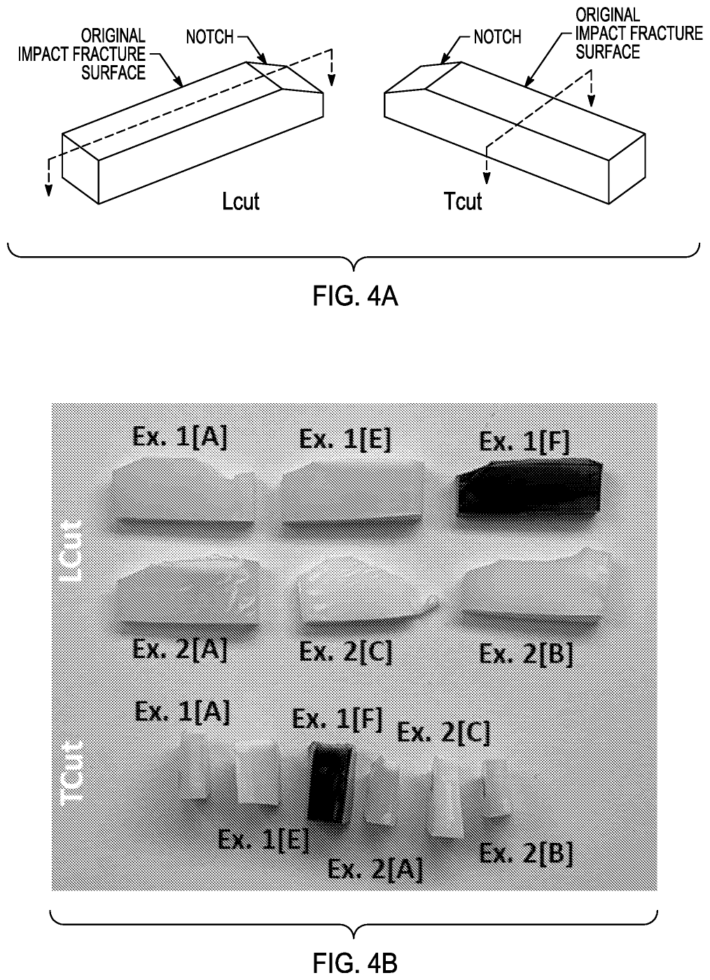

A schematic of one-half of a fractured impact tested bar is shown in the left side of FIG. 4A. The bar was sliced down the middle along the fracture path starting from the notch end. This resulted in two halves, one of which is shown as for each Example as longitudinal or “L_{CUT}” samples in the photograph of FIG. 4B, with the original impact fracture running along the top edge from left (notch) to right. The second half of the fractured impact bar was cut perpendicular to the fracture path from the side at the halfway point (4-mm from start or end of fracture) to yield a transverse or “T_{CUT}” section and is shown on the right side of FIG. 4A and in the bottom row of the photograph of FIG. 4B.

The depth of the stress whitening zone at the mid-point of the fractured surface as seen in the “T_{CUT}” or transverse cross-section was measured and recorded in Table 4 for each sample. A total of three specimens were cut for each sample type with a minimum of three measurements taken per specimen. The visually observed stress whitening zones in the “L_{CUT}” and “T_{CUT}” specimens are photographically shown in FIG. 4B.

TABLE 4
Stress whitening determination after impact testing at −30° C.

| | | Stress Whitening Zone Thickness @ Halfway Point |
|---|---|---|
| Test | Material | through Fracture in T_{CUT} direction |
| Specimen | Class | (values in microns) |
| 1A | PA66 | 323 |
| 1E | PA66 | 627 |
| 1F | PA66 | 430 |
| 2A | PA12 | 483 |
| 2B | PA612 | 0 |
| 2C | PA66 | 0 |

It was observed that the impact test bar stress whitening zone thickness for the Ex. 1E specimen in the PA66 material class was unexpectedly larger than the other tested specimens. Though not bound by any theory, a larger stress whitening zone developed upon impact may be an indication of increased impact energy dissipation resulting in superior fracture toughness.

### Porosity and Shear Yielding Characterization of Impact Tested Specimens.

Fractured bars from ISO 179/2-1eA notched Charpy impact tests conducted at −30° C. for Table 2 specimens from above were evaluated for their internal microstructure including cavitation (or porosity) and shear yielding characteristics using the SEM and imaging analysis. The fracture impact bars were notched along the edge or side and then fractured at or near liquid nitrogen temperatures to yield longitudinal (parallel to the original impact bar fracture path) or transverse (perpendicular to the original impact bar fracture path) sections that would preserve the internal microstructures generated during the original impact bar fracture. This allowed detailed microstructural analysis of the areas directly below the original fracture surface in both the longitudinal and transverse orientations. Specimens were examined carefully to ensure a clean fracture prior to any analysis. The transverse fracture was done at a point halfway along the original fracture surface or ˜4 mm from the original Charpy notch.

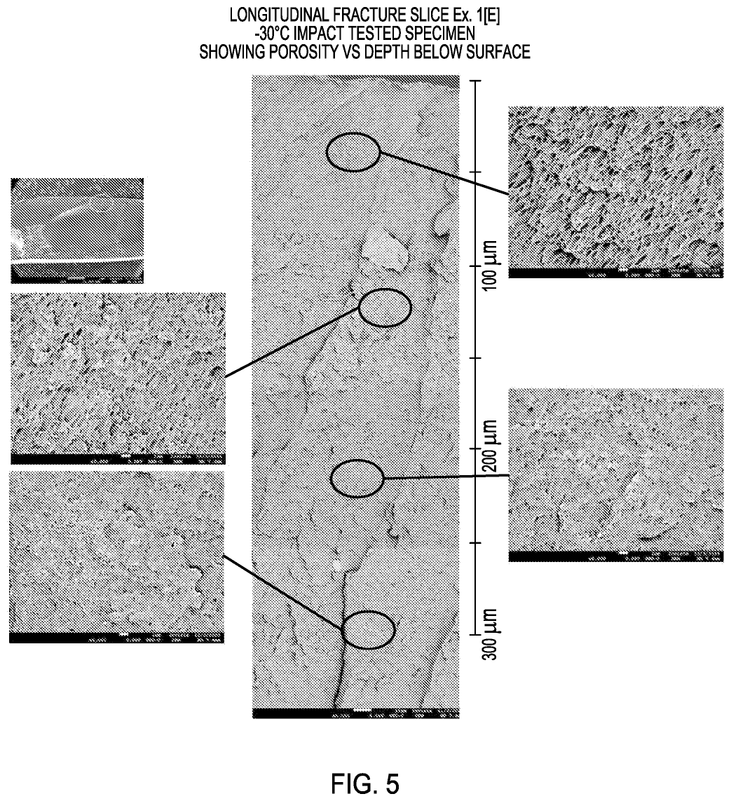

As an illustration, the Ex. 1E specimen microstructure porosity characteristics across the depth below its original fracture surface from SEM analysis are shown in FIG. 5. This longitudinal fracture slice was observed at ˜5 mm from the Charpy specimen notch. Porosity, which is readily observed in the bulk material directly below the impact fracture surface was not observed in the un-tested material. Hence, the porosity observed is a direct result of the impact fracture process. The pores immediately below the surface were elongated the most, an indication of a high degree of shear yielding and energy dissipation. Magnified views at depths of about 50 μm, about 125 μm, about 200 μm and about 300 μm also show significant amounts of porosity. The formation of pores (cavitation) and their elongation (shear yielding), which is an indication of increased energy dissipation in the bulk material, can be correlated with the relatively high impact toughness values observed at −30° C. in Table 3A. The level of porosity and aspect ratio of pores decreased as a function of depth.

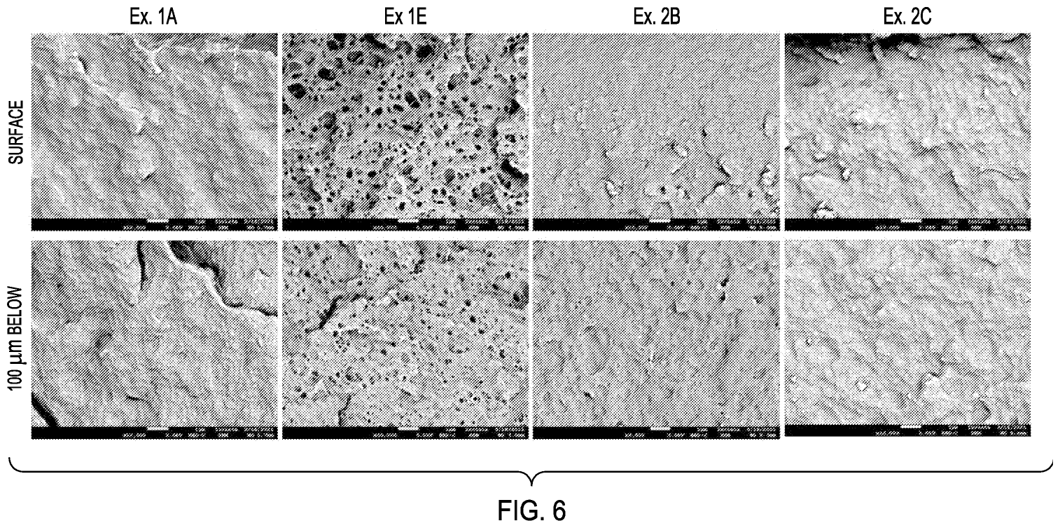

SEM images of transverse fracture slices taken perpendicular to the original Charpy fracture surface at ˜4 mm from the notch for Ex. 1A, 1E, 2B, and 2C specimens immediately below and 100 μm below the surface are shown in FIG. 6. A significant amount of porosity is observed for Ex. 1E, which is comparable to that seen in FIG. 5. Since a transverse view is shown in FIG. 6, the elongation of pores is not as apparent. In contrast with the Ex. 1E specimen, the specimens of Examples 1A, 2B, and 2C show little to no porosity directly below and at a depth of 100 μm below the surface as shown in FIG. 6. The large differences in amount of porosity and pore elongation can be translated to differences in cavitation, shear yielding and energy dissipation. Further, the increased porosity and pore elongation for Ex. 1E can be correlated with its significantly higher fracture toughness values at −30° C. reported in Table 3A relative to Examples 1A, 2B, and 2C.

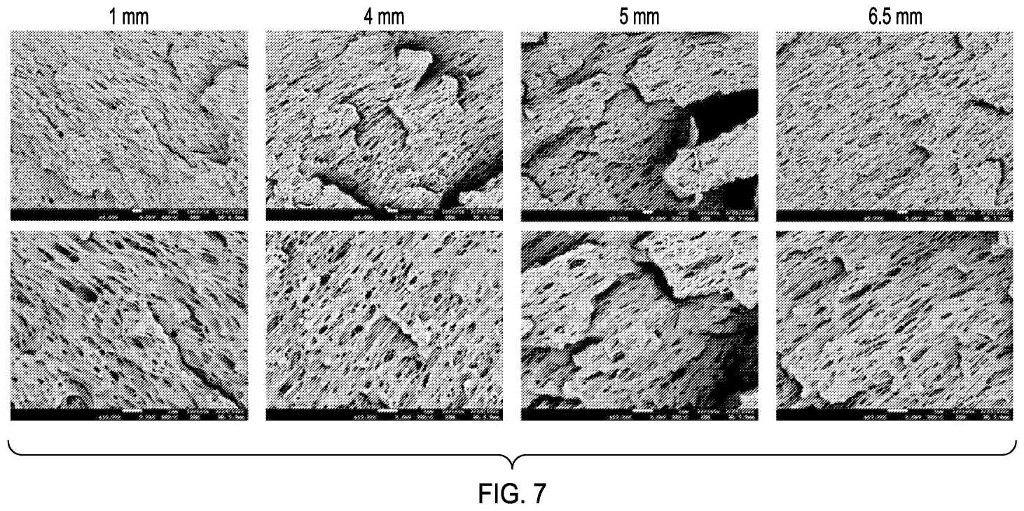

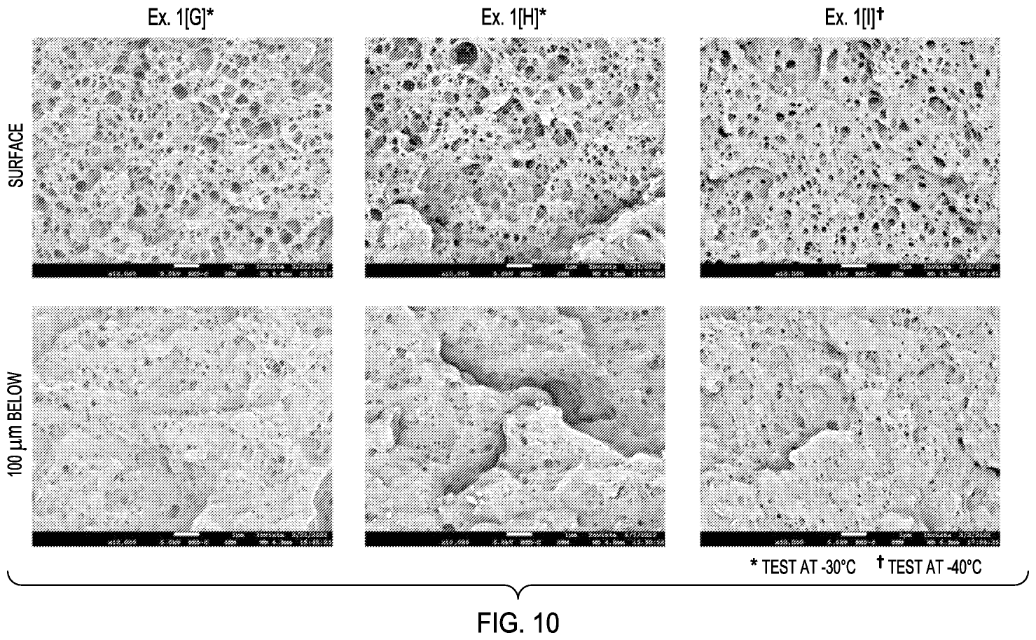

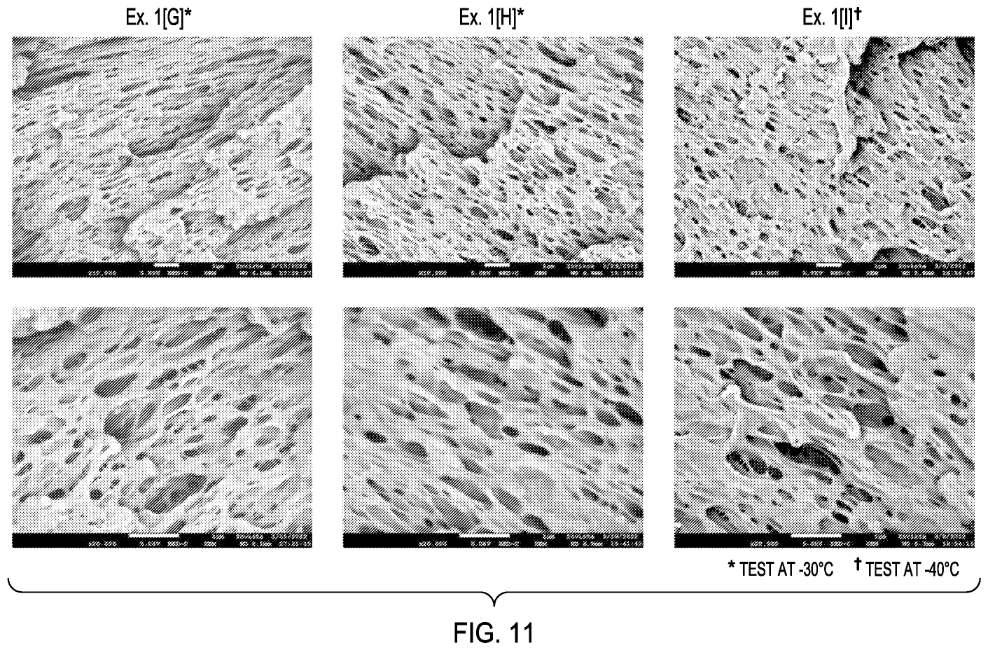

Similarly, SEM images of transverse fracture slices taken perpendicular to the original Charpy fracture surface at ˜4 mm from the notch for Ex. 1G, 1H and 1I, immediately below and 100 μm below the surface, are shown in FIG. 10. While the Ex. 1G and 1H samples were impact tested at −30° C., the Ex. 1I sample was tested at −40° C. (with an impact toughness of 77 KJ/m²). SEM images of longitudinal fracture slices taken parallel to the original Charpy fracture surface at ˜4 mm from the notch are shown in FIG. 11. The observed microstructures were consistent with those for Ex. 1E (as shown in FIGS. 6 and 7). The relatively large amounts of porosity and pore elongation can be attributed to cavitation and shear yielding which results in energy dissipation. Further, the increased porosity and pore elongation for 1G, 1H and 1I test samples can be correlated with their significantly higher low temperature fracture toughness of >70 KJ/m² relative to those observed for Examples 1A, 2B, and 2C.

The importance of porosity (cavitation) and pore elongation (shear yielding) and the resulting energy dissipation and direct correlation with −30° C. impact toughness was demonstrated above. An effort was made to quantify these microstructural features contributing to energy dissipation and improved toughness by measuring the level of porosity as % area fraction and pore elongation in terms of its aspect ratio (ratio of major to minor axis of a fitted ellipse). These measurements were made on representative SEM images using ImageJ image analysis software.

The measured porosity area fractions (%) for the −30° C. impact bar fracture specimen in the transverse cross-section at a linear distance of ˜4 mm from Charpy notch using Impact Test method ISO 179/2-1eA are represented in Table 5. Measurements were taken immediately below and at a depth of 100 μm below the surface from SEM images at 5000× and 10,000×. High magnifications were required because of the relatively small size of pores. Two automated built-in algorithms and a manual method of setting the threshold in ImageJ were used to obtain porosity area fractions. Routine background smoothing and image filtering techniques were also used. The average pore count for each data point in Table 5 was about 1250.

TABLE 5
Porosity Area Fraction for −30° C. Impact
Test fracture specimen of Ex. 1E.

| | Area Fraction (%) | |
|---|---|---|
| | Surface | 100 μm below |
| | 12.7 | 6.2 |
| | 12.5 | 6.3 |
| | 12.7 | 2.6 |
| | 17.7 | 2.9 |
| | 15.5 | 2.4 |
| | 4.9 | 5.6 |
| | 21.2 | 2.5 |
| | 24.2 | 3.7 |
| | 18.1 | 5.1 |
| | 9.5 | 3.9 |
| | 13.3 | 11.6 |
| | 18.1 | 11.6 |
| | 19.1 | 17.3 |
| | 22.0 | 8.8 |
| | 22.2 | 9.0 |
| | 22.8 | 13.7 |
| | 30.8 | 12.1 |
| | | 9.1 |
| | | 10.4 |
| Average | 17.5 | 7.6 |
| Std dev | 6.3 | 4.4 |
| Min | 4.9 | 2.4 |
| Max | 30.8 | 17.3 |

Porosity area fraction measurements similarly made using ImageJ analysis on the Ex. 1G, 1H, and 1I samples, as shown in FIG. 10, were found to be consistent with those shown for the Ex. 1E sample in Table 5.

The measured porosity aspect ratios for the −30° C. impact bar fracture specimen (Test method ISO 179/2-1eA) subsequently notched and fractured at or near liquid nitrogen temperatures in the longitudinal direction (parallel to the direction of original impact fracture) are represented in Table 6 below. Pore aspect ratios were measured on SEM images using ImageJ analysis software. Two automated built-in algorithms and a manual method of setting the threshold in ImageJ were used to obtain the average aspect ratios of pores. Routine background smoothing and image filtering techniques were also used. The average pore count for each data point in Table 6 was at least 750 or higher.

TABLE 6
Porosity Aspect Ratio for −30° C. Impact
Test fracture specimen of Ex. 1E.

Aspect ratio of pores at mm from notch

| | 1 mm | 4 mm | 5 mm | 6.5 mm |
|---|---|---|---|---|
| | 2.37 | 2.15 | 2.57 | 3.08 |
| | 2.08 | 2.11 | 2.15 | 2.80 |
| | 2.35 | 2.17 | 2.78 | 2.60 |
| | 2.35 | 2.15 | 2.60 | 2.51 |
| | 2.09 | 2.18 | 2.47 | 3.05 |
| | 2.27 | 2.14 | | 2.88 |
| | 1.99 | 2.37 | | |
| | 1.90 | 2.35 | | |
| | 2.36 | 2.31 | | |
| | 2.41 | 2.63 | | |
| | 2.07 | 2.44 | | |
| | 2.19 | 2.71 | | |
| | 2.25 | 2.65 | | |
| | 2.13 | 2.79 | | |
| | 2.22 | | | |
| Average | 2.20 | 2.37 | 2.51 | 2.82 |
| Std dev | 0.15 | 0.24 | 0.23 | 0.23 |
| Min | 1.90 | 2.11 | 2.15 | 2.51 |
| Max | 2.41 | 2.79 | 2.78 | 3.08 |

SEM images of longitudinal sections immediately below the original −30° C. Charpy impact fracture surface at various lengths from the notch (shown approximately in mm) are displayed in FIG. 7 for Ex. 1E. The images, at magnifications of both 5000× and 10,000×, portray a fairly consistent microstructure of extensive, elongated porosity along the original impact fracture length. This is an indication of cavitation and shear yielding along the entire fracture length of the −30° C. Charpy impact tested specimens.

Porosity aspect ratio measurements made using ImageJ analysis on the Ex. 1G, 1H, and 1I samples as shown in FIG. 11 were found to be consistent with those shown for the Ex. 1E sample in Table 6.

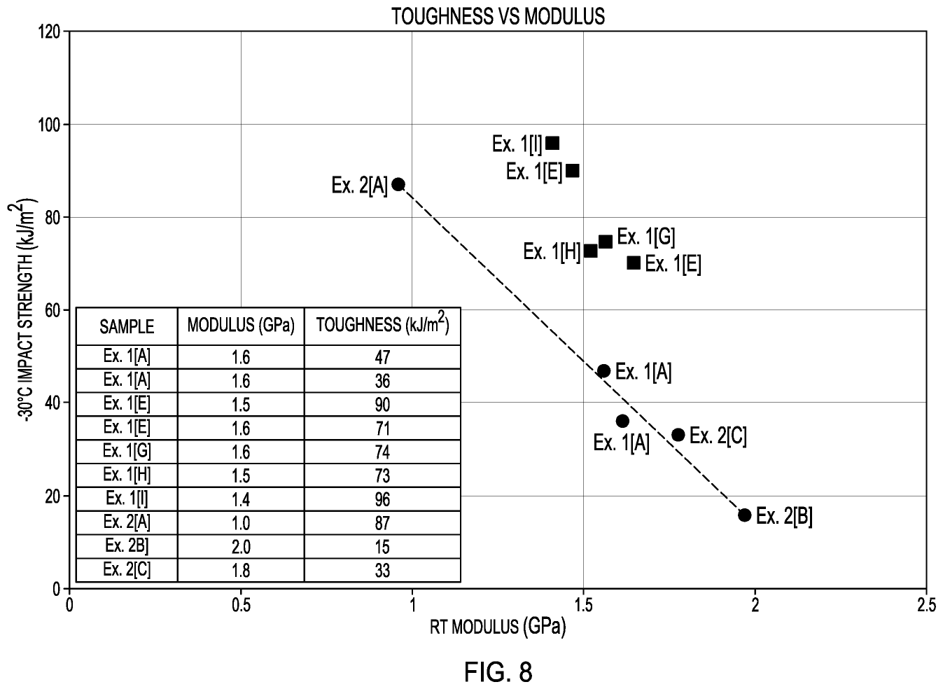

FIG. 8 represents a plot and tabulated values of measured −30° C. impact strength (KJ/m²) on the Y-axis as a function of room-temperature tensile modulus (GPa) on the X-axis. The tested specimen references and the DAM specimen data are given in Tables 3A and 3C. It was observed that the Ex. 1E, 1G, 1H, and 1I specimens were differentiated from other tested samples of Table 2. The −30° C. impact strength (kJ/m²) was more than 50% higher than all other tested specimens at identical tensile modulus. The other tested specimens all fall on a least square regression line with an R-square value of 0.98 (shown as a line in FIG. 8).

### Example 3. Room Temperature Tensile Testing

Tensile test specimens were prepared according to the ISO 527 method. Tensile testing of the specimens was conducted at room temperature in accordance with the ISO 527 test method.

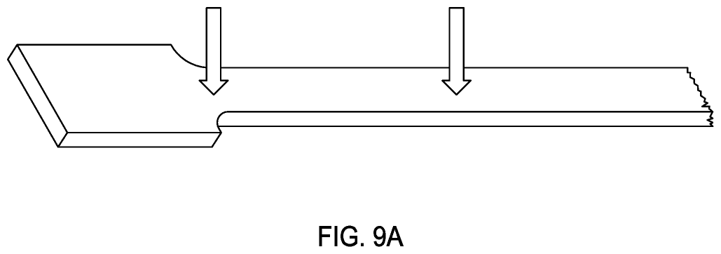

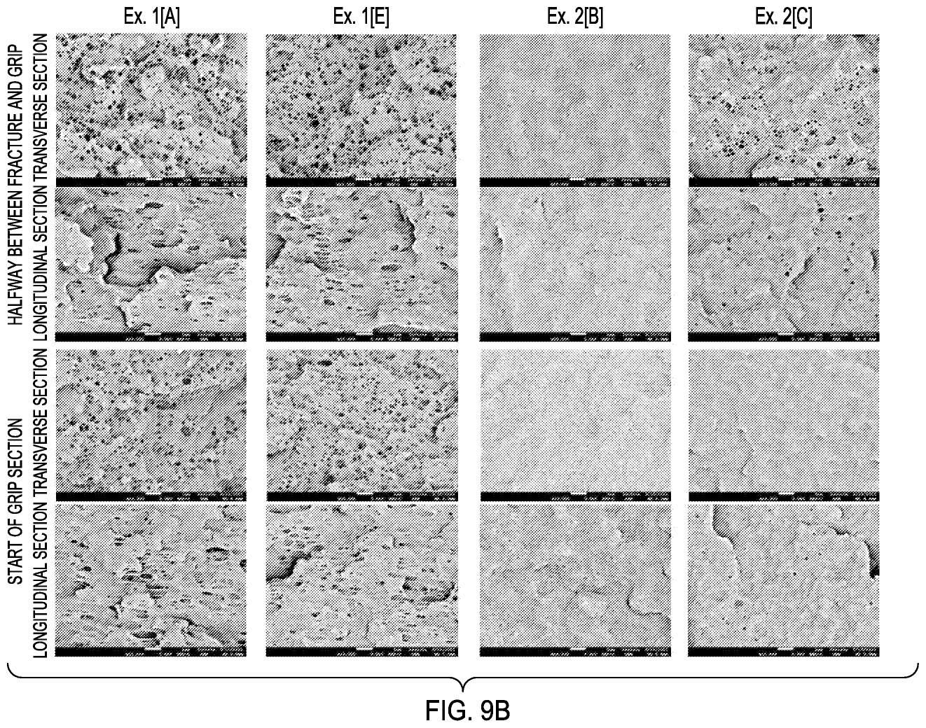

The fractured halves from tensile tests were used to evaluate the internal structures developed as a result of the tensile test. These structures offer an understanding of the internal mechanisms and material structural changes occurring during the tensile test. For each sample evaluated, the longer of the two fractured halves was selected. Sections were notched and fractured in the longitudinal and transverse directions at two locations: one halfway between the fractured surface and the grip section and the other at the start of the neck of the grip section as shown by the schematic in FIG. 9A. All fractures were done at or near liquid nitrogen temperatures to preserve the structure within the material resulting from the tensile test.

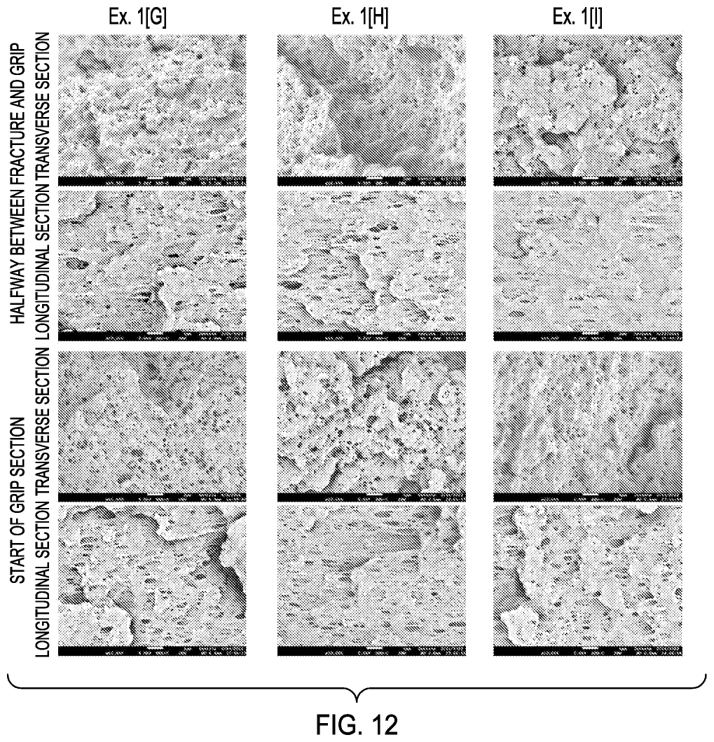

Fracture surfaces from the two regions and two orientations discussed above were examined using a JSM-7200F field emission scanning electron microscope. Care was taken that each region evaluated was a clean fracture surface to ensure that it was representative of the original as-tested internal microstructure. Micrographs were recorded from the approximate center of each sample examined. Representative micrographs at a magnification of 10,000× at each of the two locations (halfway between grip and fracture surface and at the start of the grip section) and both orientations (transverse and longitudinal, which are perpendicular and parallel to the tensile axis, respectively) are shown in FIG. 9B and FIG. 12. Porosity is clearly visible in the micrographs for both Ex. 1A and Ex. 1E at both locations. These pores are circular in appearance in the transverse orientations and elongated in the longitudinal orientations (FIG. 9B). The microstructures observed are an indication that pores have formed internally and been stretched or elongated along the axis through the application of a tensile force. No such porosity was observed in the microstructures of samples that were not subjected to the tensile test. Further, a similar elongated pore structure was observed at several other locations examined along the tensile axis and on both fractured halves of the tensile specimen for Ex. 1A and Ex. 1E. The presence of elongated pore internal microstructures throughout the tensile specimen from one end of the grip to the other are indicative of cavitation (creation of pores) and yielding (stretching of pores) which manifests itself into the relatively high elongation numbers observed for these two materials in Tables 3A and 3C. In contrast, for the materials from Ex. 2B and Ex. 2C, lower levels of porosity with almost no or very little elongation are observed in representative micrographs from both locations, particularly at the start of the grip section, as shown in FIG. 9B. Ex. 2B and Ex. 2C correspondingly exhibit relatively low levels of percent elongation after tensile testing as shown in Table 3A.

Image analysis using ImageJ software was used to quantify the area fraction and pore elongation observed in microstructures such as those shown in FIG. 9B. The level of porosity can be measured as % area fraction while elongation of pores is captured by measuring the pore aspect ratio (ratio of major to minor axis of a fitted ellipse). A longitudinal cross-section was selected from the start of the grip section of the tensile tested sample for each of Ex. 1A, 1E, 2B, and 2C. Micrographs at a magnification of 5000× (representing an area of approximately 19×24 microns) were taken from left, center and right regions of each sample, with left and right regions being about 0.5 mm in from the edges. Porosity area fractions and aspect ratios were measured using built-in automated algorithms in the software to set the threshold for each image during segmentation. The average values of area fraction and aspect ratios measured from the three micrographs described above for each sample are shown in Table 7. The substantial differences seen for area fractions and aspect ratios measured through image analysis between Ex. 1A, 1E and Ex. 2B, 2C as shown in Table 7 are in good agreement with the differences observed visually in the micrographs from the start of grip section shown in FIG. 9B. They are also in good agreement with the differences in elongation (%) observed in Table 3A, which is a measure of ductility.

TABLE 7
Image analysis results from longitudinal
sections at the start of grip.

| Sample | Area Fraction (%) | Aspect Ratio |
|---|---|---|
| 1A | 9.00 | 1.96 |
| 1E | 7.20 | 2.00 |
| 2B | <0.1 | — |
| 2C | 0.20 | 1.45 |

Subsequently, multiple frames were analyzed for Ex. 1E from longitudinal sections located at a point halfway between the tensile fracture surface and grip and at the start of the grip section at magnifications of 2000×, 5000× and 10,000×. Microstructural SEM analysis was done on samples taken from tensile bars tested at room temperature using the ISO 527 test method. As described above, notches were made in the longitudinal direction of the specimens and they were fractured at or near liquid nitrogen temperatures to preserve the structure within the material resulting from the tensile test. Two automated built-in algorithms and a manual method of setting the threshold in ImageJ were used to obtain porosity area fraction and aspect ratios from the images obtained through SEM. A summary of average values measured are shown in Table 8. The average pore count for each data point in Table 8 was at least 1000 or higher. A minimum porosity area fraction of 4% was observed for Ex. 1E.

TABLE 8
Porosity Aspect Ratio for Example 1E specimen.

| | Area fraction (%) | Aspect ratio |
|---|---|---|
| | 6.4 | 2.05 |
| | 10.4 | 1.96 |
| | 10.7 | 2.07 |
| | 10.5 | 2.10 |
| | 11.9 | 1.98 |
| | 6.4 | 2.17 |
| | 10.8 | 2.16 |
| | 6.6 | 1.93 |
| | 7.7 | 2.03 |
| | 7.3 | 2.04 |
| | 7.5 | 1.94 |
| | 8.1 | 2.41 |
| | 7.6 | 2.44 |
| | 7.7 | 1.93 |
| | 4.1 | 1.84 |
| Average | 8.2 | 2.07 |
| Std dev | 2.1 | 0.17 |
| Min | 4.1 | 1.84 |
| Max | 11.9 | 2.44 |

The Ex. 1A and 1E specimens showed 9.0% and 7.2% area fractions for porosity, respectively, while much lower (<<1%) area fractions for porosity were observed for the Ex. 2B and 2C specimens. The Ex. 1A and 1E specimens were observed with spherical porosity in the transverse section and elongated pores in the longitudinal section. In contrast, Ex. 2B and 2C specimens showed little to no porosity (in transverse direction) and pore elongations (in longitudinal direction). The increased aspect ratio of the pores for Ex. 1A and 1E may be an indication of a high degree of yielding implying large amounts of tensile elongation.

Also, the porosity and elongation of pores was consistent all the way to the start of the grip section in Ex. 1A and 1E specimens, compared to those for Ex. 2B and 2C.

The internal polymer microstructures of room-temperature, ISO 527 test method tensile test specimens of the disclosed compositions were observed to contain ≥4% porosity area fraction and ≥1.6 to ≤3.0 aspect ratio (pore major axis/minor axis) for the pores at a point halfway between the fracture surface and the grip section and at the start of both grip sections.

A high elongation of the tensile bar samples along with uniform width/thickness reduction and stress whitening along the entire elongated length was observed for tensile bars of Ex. 1A and 1E upon room-temperature testing. In contrast, highly localized necking and step fracture resulted for tensile bars of Ex. 2B and 2C upon room-temperature testing.

Porosity measurements were similarly made using ImageJ analysis on the Ex. 1G, 1H, and 1I samples in the longitudinal orientation as shown in FIG. 12. The Ex. 1G, 1H, and 1I specimens exhibited porosity aspect ratios that fell within the range ≥1.6 to ≤3.0 with a minimum porosity area fraction of 4% as observed for the Ex. 1E specimen.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a composition comprising a condensation polyamide, or a reacted product of the composition, wherein when the composition or reacted product is formed into an impact test bar and tested at −30° C. according to ISO 179/2-1eA to form a −30° C. notched impact fractured surface, the composition or reacted product has:
an S_{dr} measurement of ≥10% as obtained from a surface profilometry analysis of the −30° C. notched impact fractured surface, wherein S_{dr} represents the degree to which the actual surface area increases in comparison to a flat state; or
a stress whitening zone thickness of ≥500 microns at a halfway distance through the fracture and in a transversal surface cut plane (T_{CUT}), the transversal cut plane being perpendicular to the original fracture surface; or
a porosity area fraction (%) within the first 50 microns below the −30° C. notched impact fractured surface in a transverse cross-section direction taken at ≥3 to ≤5 mm linear distance from the notch of ≥5% to ≤31%; or
a porosity area fraction (%) at a depth of about 100 microns below the −30° C. notched impact fractured surface in a transverse cross-section direction taken at ≥3 to ≤5 mm linear distance from the notch of ≥2% to ≤17%; or
a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch of ≥1.8 to ≤3.1 and a porosity area fraction measured in the same location as the numerical mean of the aspect ratio of at least 5%; or
a combination thereof.

Aspect 2 provides the composition or reacted product of Aspect 1, wherein the S_{dr} is 10% to 30%.

Aspect 3 provides the composition or reacted product of any one of Aspects 1-2, wherein the S_{dr} is 10% to 15%.

Aspect 4 provides the composition or reacted product of any one of Aspects 1-3, wherein the stress whitening zone thickness is 500 microns to 800 microns at a halfway distance through the fracture and in the T_{CUT} plane.

Aspect 5 provides the composition or reacted product of any one of Aspects 1-4, wherein the stress whitening zone thickness is 550 microns to 700 microns at a halfway distance through the fracture and in the T_{CUT} plane.

Aspect 6 provides the composition or reacted product of any one of Aspects 1-5, wherein the porosity area fraction (%) is ≥8% to ≤27%.

Aspect 7 provides the composition or reacted product of any one of Aspects 1-6, wherein the porosity area fraction (%) is ≥12% to ≤23%.

Aspect 8 provides the composition or reacted product of any one of Aspects 1-7, wherein the numerical mean of the aspect ratio is ≥1.8 to ≤3.1 and a porosity area fraction measured in the same location as the numerical mean of the aspect ratio is at least 5%.

Aspect 9 provides the composition or reacted product of any one of Aspects 1-8, wherein the numerical mean of the aspect ratio is ≥2.0 to ≤3.0.

Aspect 10 provides the composition or reacted product of any one of Aspects 1-9, wherein the numerical mean of the aspect ratio is ≥2.1 to ≤2.8.

Aspect 11 provides the composition or reacted product of any one of Aspects 1-10, wherein a porosity area fraction (%) at a depth of about 100 microns below the −30° C. notched impact fractured surface in a transverse cross-section direction taken at ≥3 to ≤5 mm linear distance from the notch is ≥2% to ≤17%.

Aspect 12 provides the composition or reacted product of any one of Aspects 1-11, wherein a porosity area fraction (%) at a depth of about 100 microns below the −30° C. notched impact fractured surface in a transverse cross-section direction taken at ≥3 to ≤5 mm linear distance from the notch is ≥3% to ≤14%.

Aspect 13 provides the composition or reacted product of any one of Aspects 1-12, wherein a porosity area fraction (%) at a depth of about 100 microns below the −30° C. notched impact fractured surface in a transverse cross-section direction taken at ≥3 to ≤5 mm linear distance from the notch is ≥4% to ≤12%.

Aspect 14 provides a composition comprising a condensation polyamide, or a reacted product of the composition, wherein when the composition or reacted product is formed into an impact test bar and tested at −30° C. according to ISO 179/2-1eA to form a −30° C. notched impact fractured surface, the composition or reacted product has:
a porosity area fraction (%) measured within the first 50 microns below the −30° C. notched impact fractured surface in a transverse cross-section direction taken at ≥3 to ≤5 mm linear distance from the notch of ≥5% to ≤31%, and
a porosity area fraction (%) measured at a depth of about 100 microns below the −30° C. notched impact fractured surface in a transverse cross-section direction taken at ≥3 to ≤5 mm linear distance from the notch of ≥2% to ≤17%.

Aspect 15 provides a composition or reacted product of Aspect 14, wherein when the composition or reacted product thereof is formed into a tensile test bar according to ISO 527 and fractured at room temperature in accordance with ISO 527, it exhibits an internal microstructure having ≥4% porosity area fraction and an aspect ratio (pore major axis/minor axis) at a halfway point between the fracture surface and the grip sections and at the start of the grip sections of ≥1.6 to ≤3.0.

Aspect 16 provides a composition comprising a condensation polyamide, or a reacted product of the composition, wherein when the composition or reacted product thereof is formed into a tensile test bar according to ISO 527 and fractured at room temperature in accordance with ISO 527, it exhibits an internal microstructure having ≥4% porosity area fraction and an aspect ratio (pore major axis/minor axis) at a halfway point between the fracture surface and the grip sections and at the start of the grip sections of ≥1.6 to ≤3.0.

Aspect 17 provides the composition or reacted product of Aspect 16, wherein the porosity area fraction is greater than or equal to 5%.

Aspect 18 provides the composition or reacted product of any one of Aspects 16-17, wherein the porosity area fraction is ≥5% to ≤31%.

Aspect 19 provides the composition or reacted product of any one of Aspects 16-18, wherein the aspect ratio is ≥1.7 to ≤2.8.

Aspect 20 provides the composition or reacted product of any one of Aspects 16-19, wherein the aspect ratio is ≥1.8 to ≤2.5.

Aspect 21 provides a composition comprising a condensation polyamide and a maleated polyolefin, or a reacted product of the composition, the condensation polyamide comprising nylon 66, wherein the amine end group (AEG) index of the nylon 66 is ≥65 and ≤130, wherein an unpolished microtome-cut pellet formed from the composition or reacted product thereof subjected to toluene etching at 90° C. for 2 hours has a surface that, as compared using a magnification of 3000× to 5000× (e.g., using a scanning electron microscope), is less pitted than an identical composition or reacted product thereof (e.g., comparative composition or reacted product thereof) that is free of the maleated polyolefin and/or wherein the nylon 66 of the comparative composition or reacted product thereof has an amine end group (AEG) index of <65.

Aspect 22 provides the composition or reacted product of any one of Aspects 1-21, wherein when the composition or reacted product is formed into an impact test bar and tested at −30° C. according to ISO 179/2-1eA to form a −30° C. notched impact fractured surface, the composition or reacted product has an S_{dr} measurement of ≥10% as obtained from a surface profilometry analysis of the −30° C. notched impact fractured surface, wherein S_{dr} represents the degree to which the actual surface area increases in comparison to a flat state, wherein a −30° C. impact strength (KJ/m²) of the composition or reacted product is at least 40% higher at an identical tensile modulus (GPa) as compared to a composition including a condensation polyamide or reaction product thereof that does not have an S_{dr} measurement of ≥10% as obtained from a surface profilometry analysis of a −30° C. notched impact fractured surface thereof.

Aspect 23 provides the composition or reacted product of any one of Aspects 1-22, wherein when the composition or reacted product is formed into an impact test bar and tested at −30° C. according to ISO 179/2-1eA to form a −30° C. notched impact fractured surface, the composition or reacted product has a stress whitening zone thickness of ≥500 microns at a halfway distance through the fracture and in a transversal surface cut plane (T_{CUT}), the transversal cut plane being perpendicular to the original fracture surface.

Aspect 24 provides the composition or reacted product of any one of Aspects 1-23, wherein when the composition or reacted product is formed into an impact test bar and tested at −30° C. according to ISO 179/2-1eA to form a −30° C. notched impact fractured surface, the composition or reacted product has a porosity area fraction (%) measured within the first 50 microns below the −30° C. notched impact fractured surface in a transverse cross-section direction taken at ≥3 to ≤5 mm linear distance from the notch of ≥5% to ≤31%.

Aspect 25 provides the composition or reacted product of any one of Aspects 1-24, wherein when the composition or reacted product is formed into an impact test bar and tested at −30° C. according to ISO 179/2-1eA to form a −30° C. notched impact fractured surface, the composition or reacted product has a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch of ≥1.8 to ≤3.1 and a porosity area fraction measured in the same location as the numerical mean of the aspect ratio of at least 5%.

Aspect 26 provides the composition or reacted product of any one of Aspects 1-25, wherein the composition comprises:
the condensation polyamide, wherein the condensation polyamide is at least 30 wt % of the composition, wherein the condensation polyamide is the predominant polyamide in the composition; and
from ≥10 wt % to ≤50 wt % of maleated polyolefin (e.g., ≥10 wt % to ≤50 wt %, such as ≥15 wt % to ≤50 wt %, ≥15 wt % to ≤45 wt %, ≥20 wt % to ≤50 wt %, ≥20 wt % to ≤45 wt %, or less than or equal to 50 wt % but greater than or equal to 10 wt %, 11, 12, 13, 14, 15, 16, 17, 18, 19, 20, 21, 22, 23, 24, 25, 26, 27, 28, 29, 30, 35, 40, 41, 42, 43, 44, 45, 46, 47, 48, or 49%), wherein the maleated polyolefin comprises maleic anhydride grafted onto a polyolefin backbone, the maleated polyolefin having a grafted maleic anhydride incorporation of ≥0.05 to ≤1.5 wt % based on total weight of the maleated polyolefin.

Aspect 27 provides the composition or reacted product of Aspect 26, wherein the condensation polyamide is 30-99.9 wt % of the composition.

Aspect 28 provides the composition or reacted product of any one of Aspects 26-27, wherein the condensation polyamide is 60-99.9 wt % of the composition.

Aspect 29 provides the composition or reacted product of any one of Aspects 26-28, wherein the condensation polyamide is ≥40 to ≤50 wt % of the composition.

Aspect 30 provides the composition or reacted product of any one of Aspects 26-29, wherein the condensation polyamide is chosen from nylon 66, nylon 66/6T, nylon 66/6I, nylon 66/DI, and a combination thereof.

Aspect 31 provides the composition or reacted product of any one of Aspects 26-30, wherein the condensation polyamide is nylon 66 having an AEG of ≥65 milliequivalents per kg (meq/kg) and ≤130 meq/kg.

Aspect 32 provides the composition or reacted product of any one of Aspects 26-31, wherein the condensation polyamide is a nylon 66/MPMD-I copolymer.

Aspect 33 provides the composition or reacted product of any one of Aspects 26-32, wherein the condensation polyamide is chosen from nylon 66, nylon 66/6T, nylon 66/6I, and a combination thereof, and wherein the composition further comprises a nylon-6,6/MPMD-I copolymer.

Aspect 34 provides the composition or reacted product of Aspect 33, wherein the condensation polyamide is nylon 66.

Aspect 35 provides the composition or reacted product of any one of Aspects 26-34, wherein the condensation polyamide is 30 wt % to 60 wt % of the polyamide composition.

Aspect 36 provides the composition or reacted product of any one of Aspects 33-35, wherein the nylon 66/MPMD-I copolymer is a random copolymer.

Aspect 37 provides the composition or reacted product of any one of Aspects 33-36, wherein the nylon 66/MPMD-I copolymer is ≥2 to ≤50 wt % of the composition.

Aspect 38 provides the composition or reacted product of any one of Aspects 33-37, wherein the nylon 66/MPMD-I copolymer is ≥25 to ≤35 wt % of the composition.

Aspect 39 provides the composition or reacted product of any one of Aspects 26-38, wherein the composition or reacted product thereof has a recycled amine content of >0.2 wt % to ≤10 wt %.

Aspect 40 provides the composition or reacted product of any one of Aspects 26-39, wherein the composition further comprises an additional polyamide comprising nylon 66, nylon 612, nylon 610, nylon 12, nylon 6, nylon 66/6T, nylon 66/6I, nylon 66/DI, nylon 66/D6, nylon 66/DT, nylon 66/610, nylon 66/612, nylon 11, nylon 46, nylon 69, nylon 1010, nylon 1212, nylon 6T/DT, nylon DT/DI, a polyamide copolymer, or a combination thereof, wherein the additional polyamide is >0 to ≤85 wt % of the composition.

Aspect 41 provides the composition or reacted product of Aspect 40, wherein the additional polyamide is ≥15 to ≤85 wt % of the composition.

Aspect 42 provides the composition or reacted product of any one of Aspects 40-41, wherein the additional polyamide is nylon 6.

Aspect 43 provides the composition or reacted product of Aspect 42, wherein the nylon 6 is >0 to ≤1 wt % of the composition.

Aspect 44 provides the composition or reacted product of any one of Aspects 26-43, wherein the composition is free of nylon 6.

Aspect 45 provides the composition or reacted product of any one of Aspects 26-44, wherein the composition is free of reinforcing fibers.

Aspect 46 provides the composition or reacted product of any one of Aspects 26-45, wherein the composition comprises 0 wt % to 2 wt % reinforcing fibers.

Aspect 47 provides the composition or reacted product of any one of Aspects 26-46, wherein the composition comprises glass fibers.

Aspect 48 provides the composition or reacted product of Aspect 47, wherein the glass fibers are ≥1 wt % to ≤50 wt % of the composition.

Aspect 49 provides the composition or reacted product of any one of Aspects 47-48, wherein the glass fibers are ≥10 wt % to ≤42 wt % of the composition.

Aspect 50 provides the composition or reacted product of any one of Aspects 47-49, wherein the glass fibers are ≥10 wt % to ≤35 wt % of the composition.

Aspect 51 provides the composition or reacted product of any one of Aspects 47-50, wherein the glass fibers are ≥15 wt % to ≤30 wt % of the composition.

Aspect 52 provides the composition or reacted product of any one of Aspects 26-51, wherein the maleated polyolefin comprises a polyolefin backbone that comprises EPDM, ethylene-octene, polyethylene, polypropylene, or a combination thereof.

Aspect 53 provides the composition or reacted product of any one of Aspects 26-52, wherein the maleated polyolefin is free of EPDM.

Aspect 54 provides the composition or reacted product of any one of Aspects 26-53, wherein the maleated polyolefin has a grafted maleic anhydride incorporation of ≥0.1 to ≤1.4 wt % based on total weight of the maleated polyolefin.

Aspect 55 provides the composition or reacted product of any one of Aspects 26-54, wherein the maleated polyolefin has a grafted maleic anhydride incorporation of ≥0.15 to ≤1.25 wt % based on total weight of the maleated polyolefin.

Aspect 56 provides the composition or reacted product of any one of Aspects 26-55, wherein the maleated polyolefin has a glass transition temperature (T_{g}) of ≥−70° C. to ≤0° C.

Aspect 57 provides the composition or reacted product of any one of Aspects 26-56, wherein the maleated polyolefin has a glass transition temperature (T_{g}) of ≥−60° C. to ≤−20° C.

Aspect 58 provides the composition or reacted product of any one of Aspects 26-57, wherein the maleated polyolefin has a glass transition temperature (T_{g}) of ≥−60° C. to ≤−30° C.

Aspect 59 provides the composition or reacted product of any one of Aspects 26-58, wherein
the condensation polyamide has an AEG of ≥65 milliequivalents per kg (meq/kg) and ≤130 meq/kg, or
the maleated polyolefin, or domains thereof, is/are uniformly distributed in the condensation polyamide or in the composition, or
the condensation polyamide has an RV of at least 35, or
the condensation polyamide is chosen from nylon 66, nylon 66/6T, nylon 66/6I, nylon 66/DI, and a combination thereof, or
a combination thereof.

Aspect 60 provides the composition or reacted product of any one of Aspects 26-59, wherein the composition is a compounded composition comprising one or more other components.

Aspect 61 provides the composition or reacted product of Aspect 60, wherein the one or more other components comprise a modified polyphenylene ether, an impact modifier, a flame retardant, a chain extender, a heat stabilizer, a colorant additive, a filler, a conductive fiber, glass fibers, another polyamide other than the condensation polyamide, or a combination thereof.

Aspect 62 provides the composition or reacted product of any one of Aspects 60-61, wherein the one or more other components comprise a chain extender comprising a dialcohol, a bis-epoxide, a polymer comprising epoxide functional groups, a polymer comprising anhydride functional groups, a bis-N-acyl bis-caprolactam, a diphenyl carbonate, a bisoxazoline, an oxazolinone, a diisocyanate, an organic phosphite, a bis-ketenimine, a dianhydride, a carbodiimide, a polymer comprising carbodiimide functionality, or a combination thereof.

Aspect 63 provides the composition or reacted product of any one of Aspects 60-62, wherein the one or more other components comprise a chain extender, wherein the chain extender is ≥0.05 to ≤5 wt % of the compounded polyamide composition.

Aspect 64 provides the composition or reacted product of Aspect 63, wherein the chain extender comprises a maleic anhydride-polyolefin copolymer

Aspect 65 provides the composition or reacted product of any one of Aspects 1-64, wherein the composition exhibits melt strength of ≥0.3 to ≤1.0 N in a Rheotens test conducted at 270° C. to 290° C., a moisture level of 0.03-0.1%, and an extrusion speed of 300-700 mm/s.

Aspect 66 provides the composition or reacted product of Aspect 65, wherein the melt strength is ≥0.8 N to ≤1.0 N.

Aspect 67 provides the composition or reacted product of any one of Aspects 1-66, wherein the maleated polyolefin primarily resides in islands in a condensation polyamide sea.

Aspect 68 provides the reacted product of any one of Aspects 26-67, wherein the reacted product is a reaction product of the composition of any one of Aspects 26-67, wherein the reacted product comprises a polyamide-polyolefin copolymer formed from at least partial reaction of the condensation polyamide and the maleated polyolefin of the composition of any one of Aspects 26-67.

Aspect 69 provides the reacted product of Aspect 68, wherein the reacted product comprises the polyamide-polyolefin copolymer in a concentration range of ≥50 to ≤7500 ppmw, based on the total weight of the reacted product.

Aspect 70 provides the reacted product of any one of Aspects 68-69, wherein the reacted product comprises the polyamide-polyolefin copolymer in a concentration range of ≥100 to ≤4900 ppmw, based on the total weight of the reacted product.

Aspect 71 provides the reacted product of any one of Aspects 68-70, wherein the reacted product comprises the polyamide-polyolefin copolymer in a concentration range of ≥225 to ≤3750 ppmw, based on the total weight of the reacted product.

Aspect 72 provides the reacted product of any one of Aspects 26-71, wherein the reacted product exhibits melt strength of ≥0.3 to ≤1.0 N in a Rheotens test conducted at 270° C. to 290° C., a moisture level of 0.03-0.1%, and an extrusion speed of 300-700 mm/s.

Aspect 73 provides the reacted product of Aspect 72, wherein the melt strength is ≥0.8 to ≤1.0 N.

Aspect 74 provides the composition or reacted product of any one of Aspects 26-73, the composition comprising:
the condensation polyamide, wherein the condensation polyamide is at least 40 wt % of the composition, wherein the condensation polyamide is the predominant polyamide in the composition, wherein the condensation polyamide is nylon 66 having an AEG of ≥65 milliequivalents per kg (meq/kg) and ≤130 meq/kg; and
from ≥15 wt % to ≤45 wt % of maleated polyolefin, wherein the maleated polyolefin comprises maleic anhydride grafted onto a polyolefin backbone, the maleated polyolefin having a grafted maleic anhydride incorporation of ≥0.05 to ≤1.5 wt % based on total weight of the maleated polyolefin.

Aspect 75 provides an article formed from the composition or reacted product of any one of Aspects 1-74 or a combination thereof.

Aspect 76 provides the article of Aspect 75, wherein the article is resistant to cold-temperature cracking.

Aspect 77 provides the article of any one of Aspects 75-76, wherein the article is a molded article.

Aspect 78 provides the article of any one of Aspects 75-77, wherein the article is an extrudate.

Aspect 79 provides the article of any one of Aspects 75-78, wherein the article is a conduit.

Aspect 80 provides the article of Aspect 79, wherein the conduit is chosen from rigid, flexible, curved, bent, serpentine, partially corrugated, fully corrugated, and a combination thereof.

Aspect 81 provides the article of any one of Aspects 79-80, wherein the conduit has a cross-section chosen from round, oval, oblong, square, rectangle, triangle, star, polygonal, and a combination thereof.

Aspect 82 provides the article of any one of Aspects 75-81, wherein the article is substantially free of glass fibers.

Aspect 83 provides the article of any one of Aspects 75-82, wherein the article is an extruded conduit.

Aspect 84 provides the article of any one of Aspects 75-83, wherein the article is an extruded sheet.

Aspect 85 provides the article of Aspect 84, wherein the article is a folded extruded sheet.

Aspect 86 provides the article of any one of Aspects 84-85, wherein the sheet is a film.

Aspect 87 provides the article of any one of Aspects 84-86, wherein the sheet has a thickness of 0.01 mm to 10 mm.

Aspect 88 provides the article of any one of Aspects 86-87, wherein the sheet has a thickness of 0.2 mm to 6 mm.

Aspect 89 provides the article of any one of Aspects 86-88, wherein a width-to-thickness ratio of the sheet is at least 10.

Aspect 90 provides the article of any one of Aspects 86-89, wherein a width-to-thickness ratio of the sheet is ≥10 to ≤40,000.

Aspect 91 provides the article of any one of Aspects 86-90, wherein the sheet exhibits an impact resistance in kJ/m² that is within 10% of an impact resistance of a polycarbonate sheet of like thickness under like impact resistance testing conditions.

Aspect 92 provides the article of any one of Aspects 75-91, wherein the article comprises a film, a mat, a liner, a flooring, a construction material, a pad, a shutter, a panel, a belt, a slide, an enclosure, a vehicle component, an architectural component, or a combination thereof.

Aspect 93 provides the article of any one of Aspects 75-92, wherein the article comprises a slip sheet, a die cutting mat, a silo liner, a die cutting mat, a truck bed liner, flooring, a construction material, a ground pad, a construction envelope system, a storm-resistant shutter, a hail-resistant panel, a geo-textile, a conveying system component, an electronic equipment enclosure, or a combination thereof.

Aspect 94 provides a method of making the composition or reacted product of any one of Aspects 26-74 or a combination thereof, the method comprising:
combining the condensation polyamide and the maleated polyolefin to form the composition or reacted product of any one of Aspects 26-74 or a combination thereof.

Aspect 95 provides the method of Aspect 94, wherein the method comprises combining the condensation polyamide and the maleated polyolefin before adding a chain extender thereto.

Aspect 96 provides the method of Aspect 95, comprising:
providing to a first compounder extruder zone a feed comprising the condensation polyamide and the maleated polyolefin;
maintaining the first compounder extruder zone conditions sufficient to obtain a first compounded polyamide melt inside the first compounder extruder zone;
introducing a chain extender to the first compounded polyamide melt in a second compounder extruder zone; and
maintaining the second compounder extruder zone conditions sufficient to obtain a second compounded polyamide melt inside the second compounder extruder zone, wherein the second compounded polyamide melt is the composition or reacted product of any one of Aspects 26-74 or a combination thereof.

Aspect 97 provides the method of Aspect 96, wherein
a barrel of a screw extruder comprises the first compounder extruder zone and the second compounder extruder zone;
the providing of the feed to the first compounder extrusion zone comprises providing the feed to a feed inlet of the barrel;
the barrel has a length; and
the chain extender is introduced to the second compounder extruder zone at least ¼ of the length of the barrel from the feed inlet of the barrel.

Aspect 98 provides the method of any one of Aspects 96-97, wherein the introducing of the chain extender to the first compounded polyamide melt in the second compounder extruder zone comprises introducing the chain extender to the first compounded polyamide melt after at least 50 wt % of the maleated polyolefin fed has incorporated into the condensation polyamide.

Aspect 99 provides a method of extrusion of a polyamide resin, the method comprising:
providing the composition or reacted product of any one of Aspects 26-74 or a combination thereof to a feed zone of an extruder;
maintaining extruder barrel conditions sufficiently to obtain a polyamide resin melt inside the extruder; and
producing extrudate from the extruder while optionally recovering vapor from the extruder via a vacuum draw.

Aspect 100 provides a composition comprising a condensation polyamide, or a reacted product of the composition, wherein:
when the composition or reacted product is formed into an impact test bar and tested at −30° C. according to ISO 179/2-1eA to form a −30° C. notched impact fractured surface, the composition or reacted product has:
   an S_{dr} measurement of ≥10% as obtained from a surface profilometry analysis of the −30° C. notched impact fractured surface, wherein S_{dr} represents the degree to which the actual surface area increases in comparison to a flat state, or
   a stress whitening zone thickness of ≥500 microns at a halfway distance through the fracture and in a transversal surface cut plane (T_{CUT}), the transversal cut plane being perpendicular to the original fracture surface, or
   a porosity area fraction (%) within the first 50 microns below the −30° C. notched impact fractured surface in a transverse cross-section direction taken at ≥3 to ≤5 mm linear distance from the notch of ≥5% to ≤31%, or
   a porosity area fraction (%) within the first 50 microns below the −30° C. notched impact fractured surface in a transverse cross-section direction taken at ≥3 to ≤5 mm linear distance from the notch of ≥5% to ≤31% and a porosity area fraction (%) at a depth of about 100 microns below the −30° C. notched impact fractured surface in a transverse cross-section direction taken at ≥3 to ≤5 mm linear distance from the notch of ≥2% to ≤17%, or
   a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch of ≥1.8 to ≤3.1 and a porosity area fraction measured in the same location as the numerical mean of the aspect ratio of at least 5%, or
   a combination thereof; or
when the composition or reacted product thereof is formed into a tensile test bar according to ISO 527 and fractured at room temperature in accordance with ISO 527, it exhibits an internal microstructure having ≥4% porosity area fraction and an aspect ratio (pore major axis/minor axis) at a halfway point between the fracture surface and the grip sections and at the start of the grip sections of ≥1.6 to ≤3.0; or
   a combination thereof.

Aspect 101 provides the composition, reacted product, article, or method of any one or any combination of Aspect 1-100 optionally configured such that all elements or options recited are available to use or select from.

What is claimed is:

1. A composition or a reacted product thereof, the composition comprising:
a condensation polyamide, wherein the condensation polyamide is at least 30 wt % of the composition, wherein the condensation polyamide is the predominant polyamide in the composition; and
from ≥10 wt % to ≤50 wt % of maleated polyolefin, wherein the maleated polyolefin comprises maleic anhydride grafted onto a polyolefin backbone, the maleated polyolefin having a grafted maleic anhydride incorporation of ≥0.05 to ≤1.5 wt % based on total weight of the maleated polyolefin.

2. The composition or reacted product of claim 1, wherein the condensation polyamide is 30-99.9 wt % of the composition.

3. The composition or reacted product of claim 1, wherein the condensation polyamide is chosen from nylon 66, nylon 66/6T, nylon 66/6I, nylon 66/DI, and a combination thereof.

4. The composition or reacted product of claim 1, wherein the condensation polyamide is nylon 66.

5. The composition or reacted product of claim 1, wherein the condensation polyamide is nylon 66 having an AEG of ≥65 milliequivalents per kg (meq/kg) and ≤130 meq/kg.

6. The composition or reacted product of claim 1, wherein the condensation polyamide is a nylon 66/DI copolymer.

7. The composition or reacted product of claim 1, wherein the condensation polyamide is nylon 66, wherein the condensation polyamide is 30 wt % to 60 wt % of the polyamide composition, and wherein the composition further comprises a nylon-6,6/DI copolymer that is ≥2 to ≤50 wt % of the composition.

8. The composition or reacted product of claim 1, wherein the composition further comprises an additional polyamide comprising nylon 66, nylon 612, nylon 610, nylon 12, nylon 6, nylon 66/6T, nylon 66/6I, nylon 66/DI, nylon 66/D6, nylon 66/DT, nylon 66/610, nylon 66/612, nylon 11, nylon 46, nylon 69, nylon 1010, nylon 1212, nylon 6T/DT, nylon DT/DI, a polyamide copolymer, or a combination thereof, wherein the additional polyamide is >0 to ≤85 wt % of the composition.

9. The composition or reacted product of claim 1, wherein the composition comprises glass fibers, wherein the glass fibers are ≥1 wt % to ≤50 wt % of the composition.

10. The composition or reacted product of claim 1, wherein the maleated polyolefin comprises a polyolefin backbone that comprises EPDM, ethylene-octene, polyethylene, polypropylene, or a combination thereof.

11. The composition or reacted product of claim 1, wherein the composition is a compounded composition comprising one or more other components, wherein the one or more other components comprise a modified polyphenylene ether, an impact modifier, a flame retardant, a chain extender, a heat stabilizer, a colorant additive, a filler, a conductive fiber, glass fibers, another polyamide other than the condensation polyamide, or a combination thereof.

12. The composition or reacted product of claim 1, wherein the composition and/or the reacted product exhibits melt strength of ≥0.3 to ≤1.0 N in a Rheotens test conducted at 270° C. to 290° C., a moisture level of 0.03-0.1%, and an extrusion speed of 300-700 mm/s.

13. The reacted product of claim 1, wherein the reacted product is a reaction product of the composition of claim 1, wherein the reacted product comprises a polyamide-polyolefin copolymer formed from at least partial reaction of the condensation polyamide and the maleated polyolefin of the composition of claim 1.

14. The composition or reacted product of claim 1, the composition comprising:
the condensation polyamide, wherein the condensation polyamide is at least 40 wt % of the composition, wherein the condensation polyamide is the predominant polyamide in the composition, wherein the condensation polyamide is nylon 66 having an AEG of ≥65 milliequivalents per kg (meq/kg) and ≤130 meq/kg; and
from ≥20 wt % to ≤50 wt % of maleated polyolefin, wherein the maleated polyolefin comprises maleic anhydride grafted onto a polyolefin backbone, the maleated polyolefin having a grafted maleic anhydride incorporation of ≥0.05 to ≤1.5 wt % based on total weight of the maleated polyolefin.

15. The composition or reacted product of claim 1, wherein when the composition or reacted product is formed into an impact test bar and tested at −30° C. according to ISO 179/2-1eA to form a −30° C. notched impact fractured surface, the composition or reacted product has:
an S_{dr} measurement of ≥10% as obtained from a surface profilometry analysis of the −30° C. notched impact fractured surface, wherein S_{dr} represents the degree to which the actual surface area increases in comparison to a flat state; or
a stress whitening zone thickness of ≥500 microns at a halfway distance through the fracture and in a transversal surface cut plane (T_{CUT}), the transversal cut plane being perpendicular to the original fracture surface; or
a porosity area fraction (%) within the first 50 microns below the −30° C. notched impact fractured surface in a transverse cross-section direction taken at ≥3 to ≤5 mm linear distance from the notch of ≥5% to ≤31%; or
a porosity area fraction (%) at a depth of about 100 microns below the −30° C. notched impact fractured surface in a transverse cross-section direction taken at ≥3 to ≤5 mm linear distance from the notch of ≥2% to ≤17%; or
a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch of ≥1.8 to ≤3.1 and a porosity area fraction measured in the same location as the numerical mean of the aspect ratio of at least 5%; or
a combination thereof.

16. The composition or reacted product of claim 1, wherein when the composition or reacted product thereof is formed into a tensile test bar according to ISO 527 and fractured at room temperature in accordance with ISO 527, it exhibits an internal microstructure having ≥4% porosity area fraction and an aspect ratio (pore major axis/minor axis) at a halfway point between the fracture surface and the grip sections and at the start of the grip sections of ≥1.6 to ≤3.0.

17. The composition or reacted product of claim 1, or a reacted product of the composition, the condensation polyamide comprising nylon 66, wherein the amine end group (AEG) index of the nylon 66 is ≥65 and ≤130, wherein an unpolished microtome-cut pellet formed from the composition or reacted product thereof subjected to toluene etching at 90° C. for 2 hours has a surface that, as compared using a magnification of 3000× to 5000×, is less pitted than an identical composition or reacted product thereof wherein the amine end group (AEG) index of the nylon 66 is <65.

18. An article formed from the composition or reacted product of claim 1.

19. A method of making the composition of claim 1, the reacted product thereof, or a combination thereof, the method comprising:
combining the condensation polyamide and the maleated polyolefin to form the composition of claim 1, the reacted product thereof, or a combination thereof.

20. A composition comprising a condensation polyamide, or a reacted product of the composition, wherein:
when the composition or reacted product is formed into an impact test bar and tested at −30° C. according to ISO 179/2-1eA to form a −30° C. notched impact fractured surface, the composition or reacted product has:
an S_{dr} measurement of ≥10% as obtained from a surface profilometry analysis of the −30° C. notched impact fractured surface, wherein S_{dr} represents the degree to which the actual surface area increases in comparison to a flat state, or
a stress whitening zone thickness of ≥500 microns at a halfway distance through the fracture and in a transversal surface cut plane (T_{CUT}), the transversal cut plane being perpendicular to the original fracture surface, or
a porosity area fraction (%) within the first 50 microns below the −30° C. notched impact fractured surface in a transverse cross-section direction taken at ≥3 to ≤5 mm linear distance from the notch of ≥5% to ≤31%, or
a numerical mean of the aspect ratio (pore major axis/minor axis) of a representative sample of pores measured within the first 50 microns below the −30° C. notched impact fractured surface and along a longitudinal cross-section taken at ≥3 to ≤5 mm linear distance from the notch of ≥1.8 to ≤3.1 and a porosity area fraction measured in the same location as the numerical mean of the aspect ratio of at least 5%, or
a combination thereof; or
when the composition or reacted product thereof is formed into a tensile test bar according to ISO 527 and fractured at room temperature in accordance with ISO 527, it exhibits an internal microstructure having ≥4% porosity area fraction and an aspect ratio (pore major axis/minor axis) at a halfway point between the fracture surface and the grip sections and at the start of the grip sections of ≥1.6 to ≤3.0; or
a combination thereof.
